(19) United States
(12) Patent Application Publication
(10) Pub. No.: US 2026/0095849 A1
(43) Pub. Date: Apr. 2, 2026

(54) METHOD FOR CARRIER WAVE NODE SELECTION FOR AMBIENT IOT

(71) Applicant: InterDigital Patent Holdings, Inc., Wilmington, DE (US)

(72) Inventors: Remun Koirala, London (GB); Erdem Bala, East Meadow, NY (US); Paul Marinier, Brossard (CA); Martino Freda, Laval (CA); Moon IL Lee, Melville, NY (US); Aata El Hamss, Laval (CA); Jongwoo Hong, New York, NY (US); Patrick Tooher, Montreal (CA)

(73) Assignee: InterDigital Patent Holdings, Inc., Wilmington, DE (US)

(21) Appl. No.: 18/901,876

(22) Filed: Sep. 30, 2024

(51) Int. Cl. H04W 48/20; H04L 5/00; H04W 72/044

(52) U.S. Cl. CPC H04W 48/20; H04L 5/0007; H04W 72/046; H04W 72/0473

(57) ABSTRACT

In one or more systems, method, and/or apparatuses, a carrier wave (CW) node may be selected for ambient internet of things (AIoT) device communication. In one example, one or more apparatuses (e.g., the CW node itself or one or more other entities), may require configuration to establish and facilitate communication with the AIoT device(s). In one example, a wireless transmit receive unit (WTRU) may select one or more transmission CW node(s) based on measurements from one or more candidate CW node(s). The WTRU may determine the transmission characteristics of the selected transmission CW node(s), and instruct the same.

### BACKGROUND

IoT (Internet of Things) devices may rely heavily on carrier waves for communication. These devices may use wireless communication protocols that utilize carrier waves to transmit data. By modulating these carrier waves, IoT devices may encode and send information, enabling seamless connectivity and data exchange in uses cases where other non-IoT deices may not be well suited (e.g., power requirements, reception, costs, etc.). It is therefore important to address how communication is handled between a larger communications network and one or more IoT devices.

### SUMMARY

In one or more systems, method, and/or apparatuses, a carrier wave (CW) node may be selected for ambient internet of things (AIoT) device communication. In one example, one or more apparatuses (e.g., the CW node itself or one or more other entities), may require configuration to establish and facilitate communication with the AIoT device(s). In one example, a wireless transmit receive unit (WTRU) may select one or more transmission CW node(s) based on measurements from one or more candidate CW node(s). The WTRU may determine the transmission characteristics of the selected transmission CW node(s), and instruct the same.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 illustrates an example of two topologies for ambient Internet of Things (IoT) devices.

FIG. 3 illustrates an example signaling diagram for capability reporting and configuration.

FIG. 4 illustrates an example of CW time window parameters and trigger.

FIG. 5 illustrates an example of a CW transmission from candidate notes and an intermediate WTRU.

FIG. 6 illustrates an example of measurements and the selection of a candidate CW node based on measurements.

FIG. 7 illustrates an example of the time availability of one or more transmission CW nodes.

FIG. 8 illustrates an example of selecting a transmission beam to avoid interference with a WTRU and a reader in close proximity.

FIG. 9 illustrates an example of signaling for reporting transmission CW configurations.

FIG. 10 illustrates an example of signaling for requesting transmission of CW configurations.

FIG. 11 illustrates an example of signaling for a WTRU to indicate CW configuration to another reader.

FIG. 12 illustrates an example method according to one or more embodiments disclosed herein.

### DETAILED DESCRIPTION

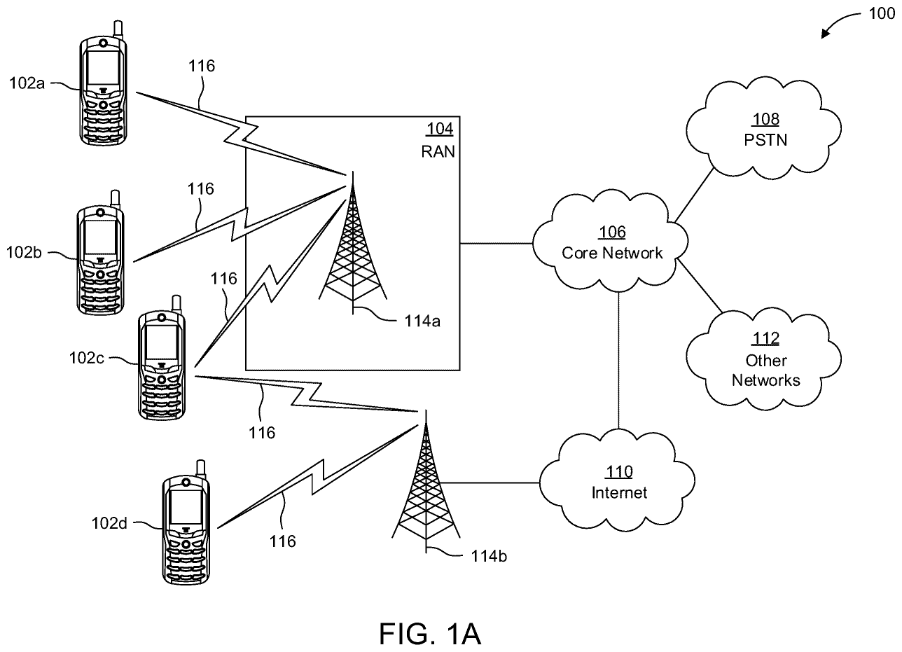

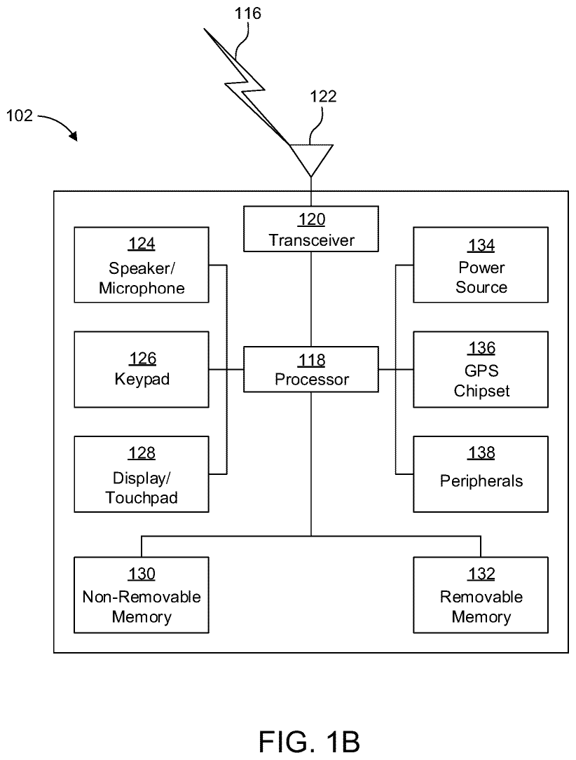

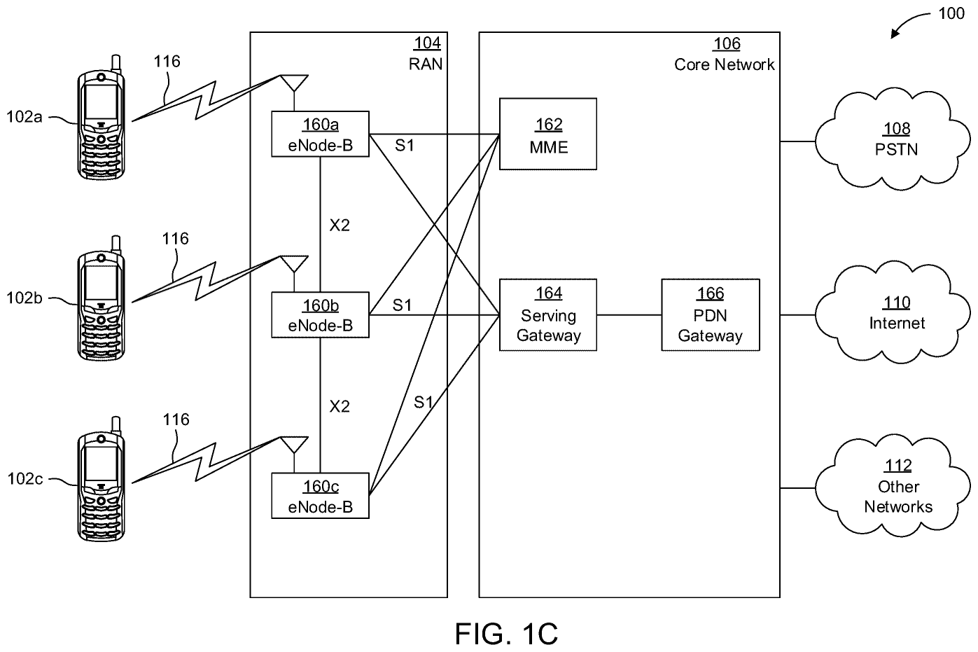

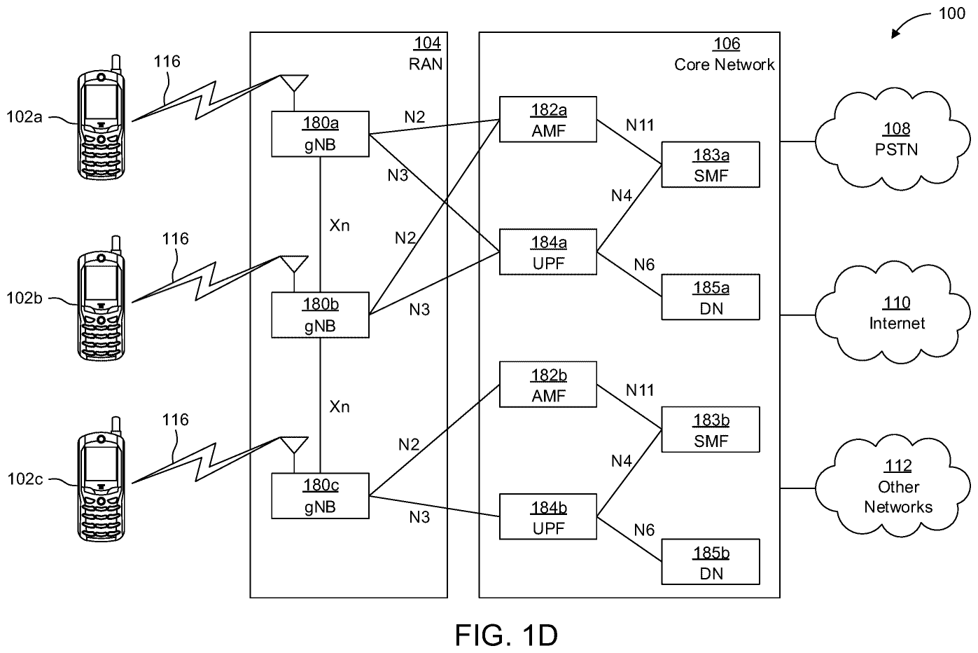

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (WTRU), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements. In one case, a base station may be distributed (e.g., different units that address or include different functions/layers/protocols/hardware/etc.; a first unit, second unit, etc.).

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

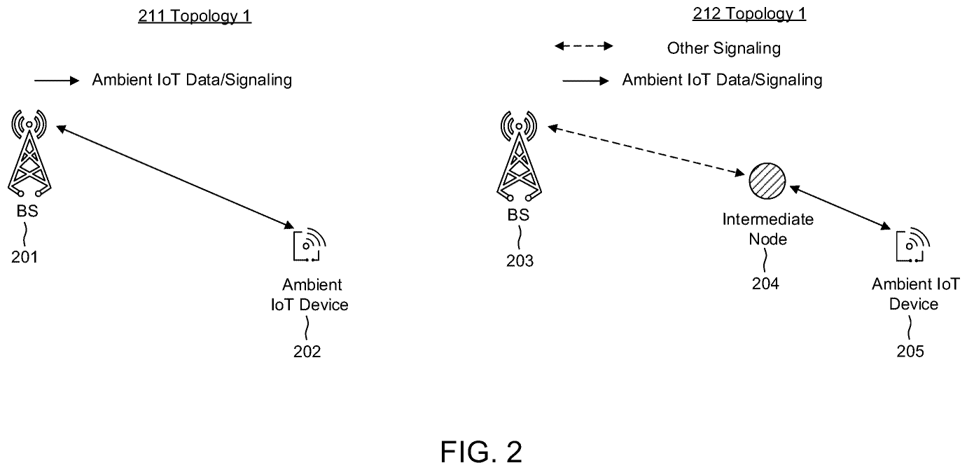

FIG. 2 illustrates an example of two topologies for ambient Internet of Things (AIoT) devices. As described herein, a device(s) may refer to one or more IoT device(s), AIoT(s), AIoT device(s), and/or ambient device(s), all of which may be interchangeable herein.

Generally, an ambient IoT (AIoT) device (e.g., low complexity) may be a small and/or reduced capability IoT device (e.g., relative to another IoT device or other WTRU equivalent) that operates based on ambient energy (e.g., through harvesting energy through some other form of energy, such as radio waves, light, motion, heat, etc.). These devices may either be battery-less or have limited energy storage capabilities. A device may connect to a network via a reader. A reader may be another device, such as a WTRU, or a network node as described herein (e.g., BS, function, etc.); the reader may be interchangeable with either of these terms. Where a device relies on capturing energy from the reader, then whatever device the reader is must be capable of delivering this energy. Alternatively, the device may capture energy for operating from elsewhere besides the reader.

There are various use cases for ambient IoT devices that may serve as the basis for grouping them into different categories (e.g., indoor and outdoor inventory, sensors, positioning, and/or command) and/or by topologies/deployment scenarios. These devices may be further categorized by type based on these groupings and/or other characteristics.

For example, one type (e.g., type 1) of device may operate at ˜1 μW peak power consumption without either DL or UL amplification in the device (e.g., may have neither DL nor UL amplification in the device). This type of device may have energy storage, initial sampling frequency offset (SFO) up to 10× ppm. The device's UL transmission may be backscattered on a carrier wave provided externally.

For example, one type (e.g., type 2a) of device may operate at ˜1 μW peak power consumption with either DL or UL amplification in the device (e.g., may have DL or UL amplification in the device). This type of device may have energy storage, initial sampling frequency offset (SFO) up to 10× ppm. The device's UL transmission may be backscattered on a carrier wave provided externally. This type of device is similar the type 1 device except that it may use DL and/or UL amplification.

For example, one type (e.g., type 2b) of device may operate at ≤a few hundred μW peak power consumption, have energy storage, initial sampling frequency offset (SFO) up to 10× ppm, and/or may have both DL and/or UL amplification in the device. The device's UL transmission may be generated internally by the device, or be backscattered on a carrier wave provided externally.

Generally, all device types may be able to receive and demodulate data and control messages from different RAN entities (e.g., base station, WTRU, network functions, etc.). The manner in which an ambient IoT device connects with a network may be related to the topology of a given system. While specific device types are discussed herein, it is intended that reference to a specific device type is for illustrative purposes, and could be replaced with reference to just a device of any type, unless specified otherwise.

As shown in FIG. 2, in a first topology (e.g., topology 1), there is a reader that is a BS that connects (e.g., ambient IoT data/signaling/etc.) to an ambient IoT device. In a second topology (e.g., topology 2), there is a base station that has an intermediary connection with an intermediary node that acts as the reader, which in turn connects to an ambient IoT device. In all the topologies, the Ambient IoT device may be provided/sent/broadcasted with a carrier wave (CW) from the reader or other node(s) either inside or outside the topology. In one example, a carrier wave is a continuous wave.

Ambient IoT devices (e.g., devices 1 and 2a) may transmit by backscattering a CW signal transmitted by a reader or a CW node. The signal may include a single tone or multiple tones transmitted simultaneously (multi-carrier) or sequentially (frequency hopping). A device may transmit information by reflecting or absorbing the signal. As described herein, a CW node may or may not be a reader. A reader in a given network architecture may have more than one role (e.g., receive/transmit Device to Reader (D2R) and/or Reader to Device (R2D) signals). A CW node (e.g., either as a reader or as not a reader from the perspective of the network architecture) may have a primary functionality of transmitting a CW signal.

A CW signal may refer to any signal (e.g., a continuous wave signal, a reference signal, a modulated continuous wave signal, a sine wave signal) that may be at least backscattered on by the devices and/or received and/or measured by a reader. A candidate CW node may refer to one or more CW nodes that may transmit the CW signal to the devices. In one example, the reader may be considered a candidate CW node if it transmits a CW signal to the devices and/or participates in the CW node selection procedure. A transmission CW node may refer to one or more CW nodes that may be selected for transmission of CW signal to the devices or the WTRU during one or more ambient IoT procedures (e.g., random access, command, etc.). In one example, the transmission CW node may be selected as a subset of the candidate CW nodes.

In the context of the figures and their corresponding descriptions, some terms used herein may have specific meanings, may be interchangeable with other terms as explained, and/or may have generally accepted meanings as they are known at the time of filing.

A WTRU may be an ambient Internet of Things (IoT) device, and the two terms may be interchangeable as described herein. Further, an “ambient IoT device” or a “device” may refer to a device (e.g., IoT device) that may be able to transmit and/or backscatter and/or receive data/ID(s) and/or control signals to and/or from RAN entities (e.g., bases station, WTRU, network etc.). A “WTRU” may refer to the reader or an “intermediate WTRU” from the ambient IoT topology 2 and may be used interchangeably with “reader” or “TRP” or “BS” or “Network” or any other entity (e.g., RAN entity) that can transmit and or receive the signals and messages (e.g., data signals, control messages, etc.) with the device or the ambient IoT device.

A “TRP” may be used interchangeably with a base station (BS) (e.g., a gNB).

A “Network” may refer to a BS and/or other nodes/functions/entities (e.g., gNB/AMF/UPF/LMF etc.).

“Pre-configuration” and “configuration” may be used interchangeably.

“ID(s)” may be used interchangeably with index/indices.

“Occasion” may refer to an opportunity for device transmission that may be delimited by the transmission of a query rep message (or similar). Alternatively, an occasion may include both a time aspect and a frequency aspect. Wherever description indicates a selection of an occasion, such a reference may apply equivalently to the selection of a time component and/or selection of a frequency component.

Configuration or pre-configuration may refer to any configuration received by a message (e.g., an RRC message, DCI, a MAC CE, a PHY layer signal, a data PDU, a control PDU associated with any or a new protocol layer, etc.) received from either a network node or from another device or WTRU.

Any device/WTRU referenced herein may be configured by a reader, whereby the reader may be a network node or other device/WTRU (e.g., intermediate WTRU in topology 2). In the case of a WTRU, the WTRU may derive the device configuration itself, or receive the device configuration from the network, in which case, the device configuration may be relayed from the network to the device by the WTRU.

The term “other reader” or “another reader” may refer to one or more reader nodes (e.g., TRP, intermediate WTRU, etc.) that may transmit R2D signals and/or receive the D2R signals. In one example, the readers may be within the vicinity of the WTRU or a CW node (e.g., candidate CW node) or one or more device(s).

The WTRU may receive configuration (e.g., in the case of a reader WTRU in topology 2), indications, messages, requests, etc., from a network node (e.g., a BS, gNB, etc.) or another reader (e.g., intermediate WTRU) via downlink physical channel (e.g., PDSCH, PDCCH, etc.) or via lower or higher layer signaling (e.g., DCI, MAC-CE, SIB, RRC or LPP message) from the network.

In one example a WTRU may perform reporting, send messages, indications, requests, etc. to a network node (e.g., a BS, gNB, etc.) or another reader node (e.g., intermediate WTRU) via uplink physical channel (e.g., PUSCH, PUCCH, etc.) or via lower or higher layer signaling (e.g., UCI, RRC, UL-MAC CE) to the network.

The term “transmission characteristic” may refer to one or more of the configurations and/or transmission parameters (e.g., time, frequency, transmission power, transmission beam, etc.) of a signal (e.g., D2R, CW), etc.

The proximity between two entities may refer to a distance between them being below/above/at a certain threshold.

The conditions for the determination of one parameter (e.g., configuration parameter, e.g. related to at least one procedure) may depend on one or more factors. A WTRU may determine one value for the parameter if at least one of the factors are at/above a (pre)configured threshold, and another value if the factor is at/below a (pre)configured threshold.

There is a need for one or more techniques and approaches for dedicated ambient IoT devices. Specifically, the quality (e.g., SINR) of a received backscattered D2R signal(s), from device types 1 and 2a, may depend on one or more transmission properties (e.g., transmission power, beam, time/frequency resources, frequency hopping, etc.) of CW from the transmission CW node. However, without the knowledge of the channel conditions between the transmission CW node, device, and/or the reader, the CW node or the entity controlling the CW node may not be able to determine the appropriate node, select a CW node if there is more than one option, select one or more (subset) of nodes, and/or its transmission properties. This may lead to either lower quality signal reception (e.g., low SINR) or interference with the D2R receiver, other devices, and/or other readers in the proximity. In one approach, an intermediate node may assist the network in determining the transmission CW node and its transmission properties.

This approach may enable the network to determine the appropriate transmission CW node(s) and their transmission characteristics for ambient IoT transmission and reception (e.g., inventory, command, etc.). Further, this enables the D2R receptions with appropriate transmission characteristics to enable D2R receptions with appropriate measurement quality, minimize interference to the WTRU, and/or minimize interference to other readers and/or devices. Note, for the case where one of the goals is to minimize interreference to the WTRU, the transmission CW node may be the WTRU or it is another node; in the case where the transmission CW node is the WTRU, the WTRU may have self-interference, where the WTRU may have a transmission and reception at the same time (full duplex) and that may cause interreference to itself),

As described herein, an intermediary node, such as a WTRU, may be one candidate CW node, however, in some instances there may be other candidate CW nodes. A WTRU, based on measurements (e.g., of CW signals of/from the CW nodes), may determine which one or more CW nodes (e.g., a set or subset of the available candidate nodes) may be transmission CW nodes.

In one example a WTRU (e.g., the reader) may be able to transmit messages (e.g., downlink signals, control messages etc.) to one or more devices. The control messages may comprise of configurations, indications, acknowledgement message (ACKs), negative acknowledgement message (NACKs), and/or other control messages to control the transmission, reception and/or other behaviors of the devices. The data messages may comprise of the data (e.g., WTRU IDs), information, etc. to the devices.

In one example a WTRU may transmit the data and the control messages as a separate message characterized by transmission in separate time, frequency occasions and/or in different channels. In another example, the WTRU transmit the data and control messages together on the same time/frequency occasion and/or in the same channel. For instance, the WTRU may transmit a message comprising of part control message (e.g., as preamble, mid-amble, post-amble, part of message, etc.) and part data message in the same transmission.

In one example a WTRU may transmit both the control messages and data signals in the same channel. In another example, the WTRU may transmit control messages in a control channel (e.g., channel dedicated transmission and reception of a control signal) and data message in a data channel (e.g., channel dedicated to transmission and reception of a data signal). These transmissions may be in the same or different time/frequency occasions.

In one example a WTRU may transmit the downlink messages to the device in the downlink physical channel (e.g., PDSCH, PDCCH, etc.) or via lower or higher layer signaling (e.g., DCI, MAC-CE, RRC or LPP message) (e.g., defined by 3GPP) or via device specific (e.g., PRDCH) physical channels or higher or lower layer signaling specific to downlink reader to device channels.

In one example a reader (e.g., a WTRU) may be able to transmit messages (e.g., downlink signals, control messages etc.) to one or more devices. The control messages may comprise configurations, indications, acknowledgement message (ACKs), negative acknowledgement message (NACKs), and/or other control messages to control the transmission, reception and/or other behaviors of the devices. The data messages may comprise of the data (e.g., WTRU IDs), information, etc., to the devices.

In one example a WTRU may transmit the data and the control messages as a separate message characterized by transmission in separate time, frequency occasions and/or in different channels. In another example, the WTRU transmits the data and control messages together on the same time/frequency occasion and/or in the same channel. For instance, the WTRU may transmit a message comprising of part control message (e.g., as preamble, mid-amble, post-amble, part of message, etc.) and part data message in the same transmission.

In one example, the WTRU may transmit both the control messages and data signals in the same channel. In another example, the WTRU may transmit control messages in a control channel (e.g., channel dedicated transmission and reception of a control signal) and data message in a data channel (e.g., channel dedicated to transmission and reception of a data signal). These transmissions may be in the same or different time/frequency occasions.

In one example, the WTRU may transmit the downlink messages to the device in the downlink physical channel (e.g., PDSCH, PDCCH, etc.) or via lower or higher layer signaling (e.g., DCI, MAC-CE, RRC or LPP message) (e.g., defined by 3GPP) or via device specific (e.g., PRDCH) physical channels or higher or lower layer signaling specific to downlink reader to device channels.

In one example, the WTRU may receive a message(s) (e.g., data generated by the device, device ID(s), device capabilities, device data (e.g., sensor data), device information (e.g., type, available energy etc.), etc.) from the device(s).

In one example, the WTRU may receive an uplink message(s) from the device in the NR uplink physical channel (e.g., PUSCH, PUCCH, etc.) or via lower or higher layer signaling (e.g., UCI, MAC-CE, RRC or LPP message) or via other defined physical channels or higher or lower layer signaling specific to device to reader (e.g., PDRCH) channels.

In one example, the reader may receive (e.g., from the network or a device) or indicate (e.g., to the network or a device) time related indications (e.g., start time, end time, duration, periodicity, timestamp etc.) in terms of one or more of the following: absolute units such as system frame number (SFN0), symbol index, slot index, frame index, subframe index; or relative units in terms of number of symbols, number of slots, number of frames, number of subframes, seconds, with respect to a reference time. For example, duration or time offset related time indications may be indicated in terms of relative time units. For example, a reference for time indications may be one or more of the following: one or more indication, message, configuration (e.g., from the network, reader and/or devices) start time, end time, absolute time indication units etc.

In one example, the device may receive (e.g., from the network or the reader, etc.) or indicate (e.g., to the reader or network, etc.) time related indications (e.g., start time, end time, duration, periodicity, timestamp etc.) in terms of one or more of following: the time units associated with WTRU time indications as described earlier; or number of executions of a procedure, possibly triggered by a reader (e.g., number of inventory procedures, number of accesses or RACH procedures, etc.), number of messages, possibly of a specific type, or containing specific information, as described herein, received or transmitted, etc.

In one example, the WTRU or a reader may receive (e.g., from network or device) or indicate (e.g., to network or devices) frequency related indications (e.g., start frequency, end frequency, bandwidth, bandwidth part (BWP) etc.) in terms of one or more of the following: absolute units, e.g. kHz, MHz; subcarrier index and/or resource element index, resource block index (e.g., of a bandwidth part); and/or, frequency range in terms of number of subcarriers, number of REs, number of RBs, etc. with respect to a reference frequency point (e.g., Absolute radio-frequency channel number (ARFCN))

In one example, the device may receive (e.g., from network, reader or a WTRU) or indicate (e.g., to network, WTRU or a reader) in terms of units similar to as described for the WTRU.

In some cases, there may be a method for selecting a CW node. A WTRU (e.g., reader) may send configuration information to one or more devices, and the WTRU may receive configuration information from the network. The WTRU may transmit and/or receive signals, messages, and/or indications to and from the devices and/or the network. The WTRU may perform one or more measurements of one or more signals transmitted by one or more candidate CW nodes and/or from one or more ambient IoT devices. In at least one instance, the WTRU itself may be a candidate CW node. The WTRU may process the results of the measuring against one or more parameters (e.g., received in the configuration information, or preconfigures) and select one or more candidate CW nodes. The WTRU may report the selected transmission CW node(s) among the one or more candidate CW nodes. The WTRU may determine and/or report (e.g., once determined or predetermined) transmission characteristics of the selected transmission CW node(s), as further described herein. The WTRU may receive the transmission CW configuration(s) form the network and/or indicate the CW configuration(s) to the devices, etc.

As described herein, a CW node may be interchangeable used with “a WTRU (e.g., intermediate WTRU in Topology 2” or a “reader” and the definitions, procedures, indications etc. applicable for a WTRU or a reader may be applicable to a CW node).

Generally, a WTRU may be configured by the network or preconfigured to perform one or more measurement(s), for example, on the CW signal from the candidate CW nodes or D2R signals. The measurements may include reference signal received power (RSRP), received signal strength indicator (RSSI), signal-to-noise interference ratio (SINR), reference signal received quality (RSRQ), interference measurement, etc.

In one example, the RSRP measurements for an occasion (e.g., a signaling occasion) may be defined as the linear average over the power contributions (e.g., in watts, dBm, etc.) of the time and/or frequency components (e.g., occasions, symbols, slots, frames, subframes, REs, RBs etc.) associated with the occasions that carry the signals (e.g., ambient IoT D2R signals and/or CW signals, etc.).

SINR measurements for an occasion may be defined as the linear average over the power contribution (e.g., in watts, dBm, etc.) of the time and/or frequency components (e.g., occasions, symbols, slots, frames, subframes, REs, RBs, etc.) associated with the occasions that carry the signals (e.g., ambient IoT D2R signals and/or CW signals, etc.) divided by the linear average of the noise and interference power contribution (in watts, dBm, etc.).

RSSI measurements for an occasion may be defined as the linear average of the total received power (in dBm, watts, etc.) observed only in the time and/or frequency components (e.g., occasions, symbols, slots, frames, subframes, REs, RBs, etc.) from all sources, including co-channel serving and non-serving readers, adjacent channel interference, thermal noise etc. associated with the occasions that carry the signals (e.g., ambient IoT D2R signals and/or CW signals, etc.).

RSRQ may be defined as the ratio of RSRP to RSSI, over the same time and/or frequency occasions shall be made over the same set of resource blocks.

The interference measurement may be defined as the linear average over the power contributions (e.g., in watts, dBm, etc.) of the time and/or frequency components (e.g., occasions, symbols, slots, frames, subframes, REs, RBs, etc.) associated with the occasions that carry the signals (signals (e.g., ambient IoT D2R signals and/or CW signals, etc. ,) from one or more CW nodes. In one example, the interference power may include co-channel serving and non-serving readers, CW nodes, etc., adjacent channel interference, etc.

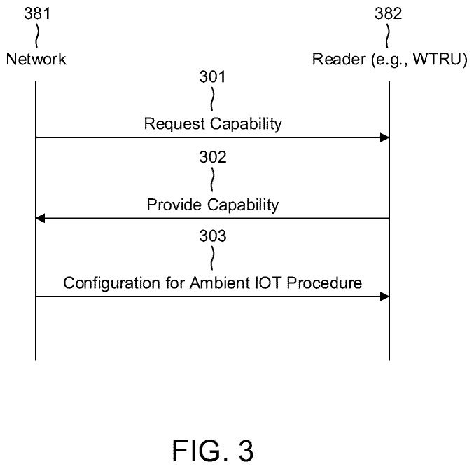

FIG. 3 illustrates an example signaling diagram for capability reporting and configuration. As shown, there may be a network 381 and a reader (e.g., WTRU) 382. In this example, the WTRU may receive a request for capability in one or more messages at 301. At 302, the WTRU may respond and provide the requested capability information in one or more messages. At 303, the network may respond with configuration information for ambient IoT procedure(s) in one or more messages.

The WTRU may receive configuration for CW node determination based on its capability reporting, where the capability report may include one or more of the: Capability of the WTRU to transmit and receive messages, control signals, etc. related with ambient IoT devices (e.g., through PDRCH and/or PRDCH, etc.); capability of the WTRU to receive and transmit ambient IoT messages (e.g., receive message(s), ID(s), etc., echo message(s), ID(s) etc.) for random access; Supported frequency band for the ambient IoT procedures (e.g., frequency range (e.g., in RE index, RB index, Hz), bandwidth etc.); Capability to perform interference measurement and/or interference cancellation based on the CW signals backscattered by the devices and the CW signals from the CW nodes; Capability to perform full duplex transmissions and receptions; and/or, capability of the WTRU to make measurements (e.g., on ambient IoT signals that may be transmitted or backscattered) and report one or more measurements).

In another example, a WTRU may receive one or more set(s) of configurations for the CW node selection via a downlink physical channel (e.g., PDSCH, PDCCH, etc.) or via lower or higher layer signaling (e.g., DCI, MAC-CE, SIB, RRC or LPP message) from the network (e.g., applicable to both scenarios where the WTRU requested the configuration or the configuration is sent unprompted).

In another example, the WTRU may send a request for the configuration information for CW selection procedures based on one or more triggering conditions, such as: the WTRU determines to perform ambient IoT procedure (e.g., random access, command, etc.); the WTRU determines interference measurement above a (pre)configured threshold (e.g., during previous procedures); the number of CW nodes and/or devices and/or readers within the proximity of the WTRU is above a (pre)configured threshold; the WTRU receives a request from the devices for CW transmission; the WTRU determines one or more measurements of D2R signal (e.g., RSRP, SINR, RSSI, interference etc.) is at, above, or below a (pre)configured threshold; the WTRU determines the number of collisions during a (e.g., previous) random access procedure (e.g., inventory procedure) is above a (pre)configured threshold; the WTRU determines the number of outage occasions (e.g., occasions where the WTRU is not able to decode the D2R signals) is above a (pre)configured threshold; the WTRU determines the number of accessed devices is at, above, or below a (pre)configured threshold; the WTRU receives an indication of high interference from other readers; and/or the WTRU receives an indication from the network.

The configuration information that is received at the WTRU, regardless of what prompts its sending (e.g., capability reporting, request, unprompted, etc.), may include one or more of the following: CW time window, WTRU CW transmission configurations, CW measurement configurations from candidate CW nodes, device configurations, other reader information, indication of a subsequent ambient IoT procedure, etc.

The configuration information of the CW time window CW Time window (e.g., ambient IoT random-access procedure and/or reserving of the resources) may include one or more of the following parameters: time window ID(s); start/end time (e.g., in terms of symbol index, slot index, frame index, subframe index, absolute time, number of transmissions, messages, indications, number of events, etc.); periodicity (e.g., in terms of number of symbols, slots, frames and/or subframes, number of transmissions, messages, indications, number of events, etc.); window duration (e.g., in terms of the number of symbols, slots, frames or subframes or milliseconds, seconds, number of transmissions, messages, indications, number of events, etc.); time offset (e.g., in terms of number of symbols, slots, frames or subframes, or milliseconds, seconds, number of transmissions, messages, indications, number of events, etc. with respect to a reference); and/or, events/conditions that may activate/deactivate the time window. In one instance, an event/condition that may activate/deactivate a time window may be an indication from the network, WTRU mobility, etc., In one instance, an event/condition that may activate/deactivate a time window may be reference time (e.g., for time offset), such as one or more of the following: time instance when WTRU receives indication for CW time window activation from the network; time instance when WTRU receives an indication or a message (e.g., random access configuration); and/or, offset with respect to SFN0 time, etc.

In an example, the WTRU may only perform the CW transmission, measurements, processing and/or reporting related to at least one of a combination of the CW node selection procedure within the indicated time window.

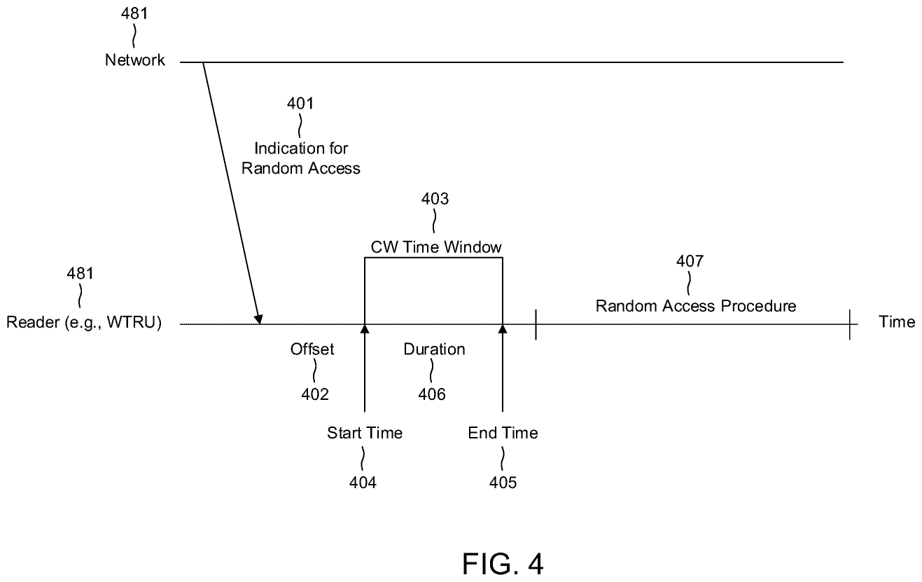

In one example, the WTRU may determine that the CW time window may be activated based on indication from the network (e.g., to initiate a random-access procedure), such as shown in the example of FIG. 4.

FIG. 4 illustrates an example of CW time window parameters and trigger. As shown, there is a network 482 and a reader 482 (e.g., a WTRU). At 401, the network may send an indication to the reader for random access. At 402, after an offset, a CW time window 403 may begin at a start time 404 and finish at an end time 405 with a duration 406. Thereafter, a random-access procedure 407 may be performed (e.g., not shown, but further exchange of messages/signals).

The configuration information of the WTRU CW transmission may include one or more of the following: transmission time indication, transmission frequency indication, transmission power, transmission beam, and/or transmission sequence and modulation scheme used for the transmission. The WTRU may be configured by the network to transmit a CW during the CW node selection procedure.

The transmission time indication may include one or more of the following: transmission start and/or end time; transmission duration; total number of transmission time occasions; duration of each transmission occasion; transmission offset with respect to a reference time (e.g., absolute time (e.g., SFN0 time), relative time (e.g., time where WTRU receives an indication, configuration, etc., start time of the activated time window, etc.); and/or, transmission periodicity.

The transmission frequency indication may include one or more of the following: transmission bandwidth (e.g., in terms of Hz, MHz, number of REs, number of RBs, etc.); total number of transmission frequency occasions; number of CW tones (e.g., single tone, multitone, 2 tones, etc.); transmission frequency per occasion (e.g., in terms of Hz, MHz, RE index, RB index, etc.); set of subcarriers (e.g., in terms of Hz, MHz, GHz, RE index, RB index, etc.); transmission frequency band (e.g., AIoT DL band, AIoT UL band, frequency indications); and/or, frequency hopping pattern. For example, the WTRU may receive an indication sequence of frequencies for transmission over time. The WTRU may receive the sequence of frequencies (e.g., F1 MHz, F2 MHz, F3 MHz) to indicate the time sequence of the frequencies to transmit on. In another example, the WTRU may also receive time indications [e.g., T1 occasion, T2 occasion, T3 occasion], to indicate which time instance to transmit the sequence on. In the above example, the WTRU may determine to transmit the CW on F1 MHz and T1 occasion, F2 MHz and T2 occasion and F3 MHz and T3 occasion.

For the transmission power, in one example, the WTRU may receive indication of transmission power (e.g., in terms of watt, dBm, etc.) from the network to transmit the CW signal. The power may be a single power or a range of power [e.g., minimum power, maximum power] or a set of power [e.g., X1 dBm, X2 dBm, etc.] If multiple power values are indicated to the WTRU, the WTRU may determine to use one or more of the indicated powers in transmission in one or more time and/or frequency resources. In another example, the WTRU may receive one or more of the transmission occasions associated with the transmission power for transmission of CW. For instance, the WTRU may receive an indication to transmit the signals in time occasion T1 with power X1 dBm, time occasion T2 with power X2 dBm and so on. In another example, the WTRU may receive an indication to transmit zero power transmission (e.g., no transmission).

For the transmission beam, in one example, the WTRU may receive an indication of transmission beam (e.g., in terms of beam ID(s), resource ID(s), resource set ID(s) etc.) or a sequence of transmission beams for CW transmission or an indication of more than one beams (e.g., set of beam ID(s)). For instance, if the WTRU receives an indication of more than transmission beam, the WTRU may be configured with the time and/or frequency occasions where the WTRU may transmit each transmission beam. In another example, the WTRU may receive an indication of a sequence [beam ID #1, beam ID #2, beam ID #3] in time occasions [T1, T2, T3], then WTRU may determine to transmit beam ID #1 in time T1, beam ID #2 in time T2, and beam ID #3 in time T3 (e.g., the determination is based on the received indication of a sequence).

For transmission sequence and or modulation scheme used for transmission, in one example, the WTRU may receive the modulation scheme (e.g., BPSK, QPSK, OOK, etc.), coding scheme (e.g., Manchester coding), and/or sequence (e.g., pseudo-random sequence, Gold sequence, Zadoff-Chu sequence, etc.) for transmission.

The configuration information for CW measurements of the candidate CW nodes may include one or more of the following: measurement quantity, candidate CE node information, candidate CW node transmission characteristic, measurement averaging, and/or measurement gap indication.

For the measurement quantity, in an example, the WTRU may receive an indication of the measurement the WTRU may perform including one or more of the SINR, RSRP, RSSI, RSRQ, interference measurements, etc.

For the candidate CW node information, the candidate CW node may be one of the CW nodes (e.g., external CW node) that may participate in the CW node selection procedure. The WTRU may be sent CW node information including one or more of the following: CW node ID, CW node type (e.g., BS, gNB, WTRU, one of RAN entity, external non-3GPP entity, etc.), CW node location, CW node available transmission time, CW node available transmission frequency, and/or CW node bandwidth.

The candidate CW node transmission characteristic (e.g., for each candidate CW node) may include one or more of the following: CW node transmission time indication, CW node transmission frequency indication, CW transmission frequency band, CW frequency hopping pattern, CW transmission power, and/or CW transmission beam. In an example, the details for candidate CW transmission characteristic may be similar to as described for CW transmission configuration for the WTRU.

For the measurement averaging, in an example, the WTRU may be sent one or more of the following: minimum and/or maximum or required number of samples and/or measurements (e.g., per transmission characteristic) that may be averaged per measurement to determine a measurement (e.g., per transmission characteristic); measurement filtering coefficients (e.g., including L3 measurement filtering coefficients, for averaging one or more measurements over more than one measurement instances).

The measurement gap indication may indicate the time reserved for measurement and/or processing the measurements. In an example, the WTRU may receive the measurement gap indication in terms of one or more symbol index, slot index, frame index, subframe index, start time, end time, relative to a reference time where the reference time may be, such as a measurement occasion.

The configuration information of the device configurations may indicate specific configuration parameters that the WTRU uses to configure the devices. Alternatively, the WTRU may be configured with default configuration parameters, or a set of configuration parameters, and the WTRU may determine the configuration of the device autonomously. The WTRU may forward the configurations or the WTRU may send the configurations to the devices so that they have it for D2R transmission. In an example, the WTRU may indicate to one or more devices (e.g., directly, or indirectly through another node) at least one of the configurations received from the network. In one case, the details of the configuration (e.g., as further described herein) may be unique to the circumstances/environment/measurements/parameters of the WTRU.

The device configurations may include one or more of the following: time indication (e.g., start time, duration, periodicity, end time, etc.), for indicating the time for D2R transmissions or backscattering; frequency indication (e.g., frequency index, number of tones, etc.) for indicating the frequency of the CW transmission nodes from the candidate CW nodes; minimum and/or maximum number of time and/or frequency occasions for the CW node selection procedure; type of time indication for D2R timing (e.g., periodic time indication, indication based); one or more of reference device ID(s) and/or a location of one or more reference device ID(s); one or more of the CW node properties (e.g., candidate CW node ID, candidate CW node location, candidate CW node transmission characteristics, etc.); D2R transmission characteristics; and/or device types or device groups the configuration may be applicable to.

The D2R transmission characteristics may include one or more of the following: D2R modulation (e.g., ASK, OOK, PIE); D2R encoding (e.g. line encoding methods, FM0 coding, Miller coding, etc.); chip duration for D2R transmission; sequence for D2R sequence; D2R amplification (e.g., in terms of multiple factor (e.g., 1.5×, 2×, etc.), dB, etc.) (e.g., if the device is capable); and/or, transmission with 0 power (e.g., no reflection).

For the device types or device groups the configuration may be applicable to, the device groups may be indicated in terms of one or more of the following: one or more devices ID(s) (e.g., reference device ID(s)); one or more devices types (e.g., device 1); one or more device locations indications (e.g., in terms of location, area (e.g., area in terms association (e.g., coverage) with one or more reader ID(s), cell ID(s), and/or e.g., area in terms of located in certain geographical area (e.g., zone ID)), distance (e.g., devices with certain distance compared to the WTRU, reader, and/or one or more of the CW nodes)); and/or one or more device characteristics. A device characteristic may be one or more of the following: devices with certain amplification capability, devices with certain energy availability (e.g., in terms of Joules), devices with certain energy storage (e.g., battery) capacity (e.g., in terms of Farad, Joules, etc.), devices with certain mobility (e.g., static, mobile, etc.), devices who participated or want to participate in one or more of ambient IoT procedures (e.g., random access), and/or devices who do not want to participate in one or more of ambient IoT procedures (e.g., random access).

For the configuration information of the other reader information, the WTRU may receive one or more of the following information associated with other readers (e.g., in the proximity of one or more of the WTRUs and/or candidate CW nodes, etc.): reader ID(s), indication of reader procedures (e.g., ambient IoT procedures); time and/or frequency indications of the reader procedures; and/or, reader locations.

The configuration information of the indication of a subsequent ambient IoT procedure may provide an indication of one or more subsequent ambient IoT procedures the WTRU may be configured to perform associated with the selection of transmission CW nodes. In an example, the WTRU may be configured for the CW node selection procedure to determine the transmission CW nodes for this subsequent procedure(s). The WTRU may be configured with one or more of the following: subsequent procedure type (e.g., random access, command, etc.); expected number of devices to serve in the procedure (e.g., N devices); expected time indication of the subsequent procedure (e.g., in terms of at least one of the WTRU CW time window or WTRU CW transmission time indication parameters); expected frequency indication of the subsequent procedure (e.g., in terms of at least one of the WTRU CW frequency indication parameters); expected number of occasions (e.g., time and/or frequency occasions) associated with the procedure; (E.g., maximum and/or minimum) number of CW nodes required; expected sustainable operation time duration required for device(s) to participate in the procedure; and/or, expected groups of devices (e.g., based on location, device properties, device types etc.) the procedure may be applicable to.

In some cases, there may be one or more measurement procedures (e.g., sub-procedures).

In one example, the WTRU may be configured to perform the CW node selection procedures only within the CW time window. The WTRU may determine to activate the CW time window based on one or more of the following conditions: the WTRU receives an indication (e.g., configuration for CW procedure, activation of CW window, etc.) from the network; and/or, the WTRU determines at least one or a combination of conditions associated with WTRU configuration request for CW selection procedures are satisfied.

In one example, the WTRU may be configured to periodically perform CW node selection procedures. In another example, the WTRU may be configured to perform CW node selection before or during one or more of the procedures (e.g., transmission, reception, etc.) related to ambient IoT devices, such as random access, command, etc., as described herein.

In one example, the WTRU may be configured to autonomously determine one or more parameters for CW time window. The WTRU may determine the CW time window parameters based one or more of the following: CW transmission time of the WTRU configured by the network; CW transmission time of the candidate CW nodes configured by the network; total number of candidate CW nodes; indicated transmission time and/or frequency of other reader ID(s) in proximity of the WTRU; maximum number of time and/or frequency occasions configured by the network; configured bandwidth for ambient IoT procedure (e.g., R2D or D2R transmissions); the determined time (e.g., start time, end time, periodicity, etc.) of one or more (e.g., subsequent) ambient IoT procedures (e.g., random access procedures, command, etc.); and/or, the velocity of the WTRU.

In one example, the WTRU may be configured to perform CW node selection procedure within a (e.g., activated) measurement window.

In one example, the WTRU may be one of the candidate CW nodes and may be configured to transmit the CW signal. In another example, the WTRU may be configured to autonomously determine the WTRU CW transmission parameters.

The WTRU may determine the transmission time and/or transmission frequency based on the configured transmission time and/or frequency indications associated with candidate CW nodes. In one example, the WTRU may determine to transmit in the time and/or frequency occasions in the occasions where one or more of the candidate CW nodes are not transmitting. The WTRU may determine to transmit in the orthogonal time and/or frequency resources compared to other candidate CW nodes.

In one example, the WTRU may determine one or more of the CW transmission characteristics (e.g., transmission beam, transmission power, etc.) in temporally, spectrally, and/or spatially orthogonal resources as compared to one or more candidate CW nodes. In another example, the WTRU may determine one or more of CW transmission characteristics temporally, spectrally and/or spatially non-orthogonally or in an overlapping manner.

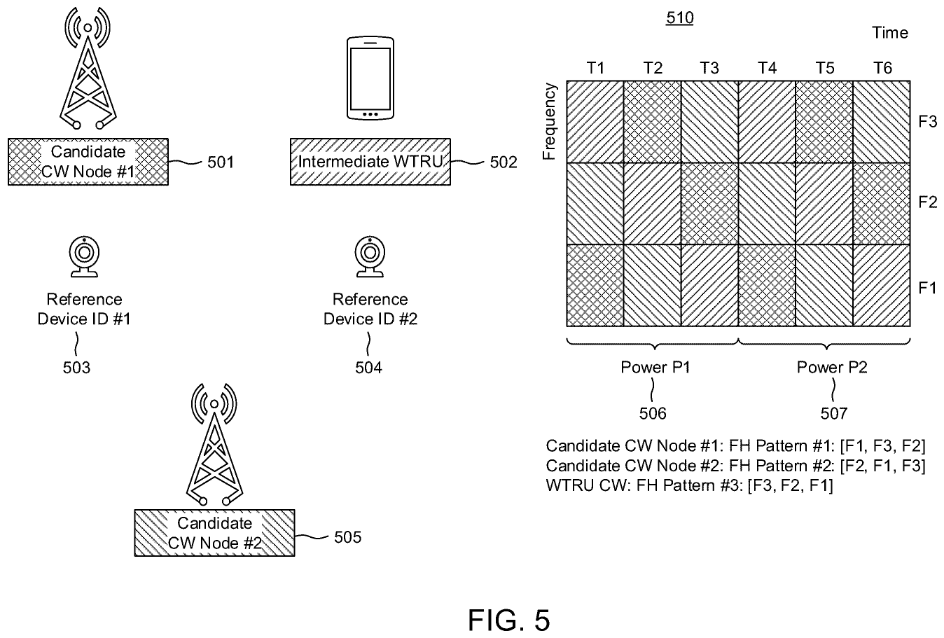

FIG. 5 illustrates an example of a CW transmission from candidate notes and an intermediate WTRU. As shown, there is a first candidate node 501, a second candidate node 505, an intermediate WTRU 502, a first reference device (ID #1) 503 and a second reference device (ID #2) 504. At 510, there is a resource graph with frequency on the vertical axis and time on the horizontal axis. Note, the pattern of the nodes/WTRU corresponds to the three different patterns used in the graph (e.g., where each square with a pattern that corresponds to one of the nodes/WTRUs illustrates the associated resource location, for this example. On the graph 510, there is a first power (P1) 506 and a second power (P2) 507. Note, while some candidate nodes illustrated appear to be similar to base stations in one or more other illustrations, as described further herein, a candidate node may be any transmitting node, such as a WTRU, base station, etc.

In an example, such as shown in FIG. 5, a WTRU may be configured with the transmission of CW signals along with candidate CW nodes #1 and #2. The candidate CW nodes (e.g., including the WTRU) may be configured to transmit in one or more time and/or frequency occasions. In one instance, the time and/or frequency occasions for each candidate CW node may be orthogonal. As shown, each candidate node may be allocated one transmission per time (e.g., T1, T2, T3, etc.) indicated by the pattern in the time frequency grid, where each pattern represents one candidate CW node. The candidate nodes may be configured with transmission power P1 and P2 where all the nodes transmit with power P1 in time durations [T1, T2 and T3] and power P2 in rest of the occasions. Similarly, the candidate CW nodes may be configured with a frequency hopping transmission, where each node transmits in different frequency resources between two time occasions. For instance, the WTRU may be configured to transmit in frequency resources [F3, F2 and F1] during time [T1, T2 and T3] and the pattern repeats for rest of the transmission.

The WTRU may determine the total number of transmission occasion(s) (for e.g., time occasion, frequency occasion) based on the (e.g., minimum or maximum) number of time and/or frequency occasions configured by the network to determine one measurement. For instance, the WTRU may be configured with a minimum number of measurements required per transmission characteristic (e.g., power) to determine a measurement and the WTRU may determine to transmit at least the required amount for such transmission characteristic. The WTRU may be configured with a minimum of 3 samples to determine a measurement per power (e.g., as shown in FIG. 5). Hence, the WTRU may determine to transmit with power P1 in at least three time and/or frequency occasions (e.g., [T1, T2 and T3]).

In one case, the WTRU may determine the transmission power based on configuration information from the network. The WTRU may receive (e.g., configured with) a set of transmission powers and may determine the transmission power to use as one or more of the set of transmission powers. In another case, the WTRU may be configured to determine a transmission power based on one or more of the (e.g., subsequent) ambient IoT procedures (e.g., random access, command, etc.). For instance, the WTRU may determine transmission power based on at least one of the following: total number of transmission time and/or frequency occasions the WTRU is configured to transmit CW signal in; total number of measurements required for measurement averaging per transmission characteristics (e.g., transmission power); the distance between the WTRU and one or more of the devices (e.g., reference device ID(s), devices the WTRU may perform subsequent procedures (e.g., command) with, etc.); the distance between the WTRU and one or more of the reader(s) (e.g., indicated by the network); the configured transmission characteristic (e.g., transmission power, transmission beam, etc.) associated with one or more of the candidate CW nodes; the area (e.g., geographical area, zone ID, etc.) where the WTRU may perform subsequent procedures (e.g., random access, command, etc.); and/or, the configuration from the network.

In one example, the WTRU may determine one transmission power if one or more factors (e.g., as described herein) are above a (pre)configured threshold, and another transmission power otherwise.

The WTRU may determine a transmission beam based on one or more sets of configured beams. In one example, the WTRU may receive an indication from the network of the transmission beam to use for CW transmission. In another example, the WTRU may determine the transmission beam based on one or more of the following: total number of transmission time and/or frequency occasions the WTRU is configured to transmit CW signal in; total number of measurements required for measurement averaging per transmission characteristics (e.g., transmission power); the location of one or more devices (e.g., reference device ID(s), devices the WTRU may perform subsequent procedures (e.g., command) with); the location of one or more reader(s) (e.g., indicated by the network); the configured transmission characteristic (e.g., transmission power, transmission beam, etc.) associated with one or more of the candidate CW nodes; and/or, the configuration from the network, etc.

In one example, the WTRU may be configured to perform sweeping of one or more transmission characteristic (for e.g., power sweeping, beam sweeping, frequency sweeping etc.). For instance, the WTRU may determine one or more sets of one or more transmission characteristics. The WTRU may determine to transmit with one or more transmission characteristic (e.g., powers [P1, P2, P3], beams [B1, B2, B3] and frequency [F1, F2, F3]) during the CW node selection procedure (E.g., Power P1 in time T1, P2 in time T2 and P3 in time T3).

In one example, the WTRU may be configured to report the determined transmission characteristics. The WTRU may subsequently receive an acknowledgement message or a CW transmission configuration from the network.

In another example, the WTRU may receive more than one set(s) of transmission configurations. Each of the transmission configurations may be associated with a configuration ID. The WTRU may determine one of the CW transmission configurations based on at least one of the conditions described herein.

The WTRU may report at least one of the configuration parameters (e.g., configuration ID, etc.) to the network. The WTRU may receive an acknowledgement or an indication of one or more configuration parameters or configurations for a CW node selection procedure.

In one example, the WTRU may be configured determine and/or transmit (e.g., broadcast, multicast, unicast, etc.) D2R configuration information to one or more devices.

In one example, the WTRU may indicate the configuration to one or more devices. The WTRU may broadcast the configuration indication to all the devices that may receive the indication. In another example, the WTRU may indicate a subset of devices that may receive the indication (e.g., multicast, unicast transmission). In another example, the WTRU may indicate at least one of the above-mentioned group indications with the intention to indicate the configuration message only to the devices satisfying the criteria.

In one example, the WTRU may receive D2R transmissions from the device if one or more of the following conditions are met: the device receives the D2R configuration indication from the reader; based one or more of the configuration information indicated; and/or the device satisfies one or more conditions associated with the group indication from the reader (e.g., for instance the device may respond if it determines: its device ID is one of the indicated device ID(s); its device type is one of the indicated types (e.g., device 1); and/or, it determines to participate in one or more of subsequent ambient IoT procedures (e.g., random access), etc.

In one example, the device may perform D2R transmission based on the indicated configuration.

In one example, the WTRU may determine the time and/or frequency configuration and/or the number of occasions (e.g., time, frequency) for devices based on the determined CW transmission time and/or frequency from one or more candidate CW nodes.

In another example, the WTRU may determine the sequence for D2R transmission based on the number of devices. In one example, the WTRU may be configured or may determine to configure the devices for orthogonal sequence transmission. In one example, the orthogonal sequences may depend on the modulation and/or encoding type. For instance, the following OOK sequences may be considered as orthogonal, 010101 and 11001100. The devices may transmit the sequence based on a WTRU indication.

In another example, the WTRU may determine to request the devices to transmit the sequence based on one or more of the ID(s) (e.g., random ID, device ID, etc.). In another example, the WTRU may request the devices to transmit the sequence based favorable autocorrelation properties, such as Gold sequence, ZC sequence, etc.

In one example, the WTRU may determine to configure the device with chip duration. In one example, the chip duration may depend on the CW transmission band from one or more candidate CW nodes. For instance, if the transmission from one or more candidate CW node is in the ambient IoT DL band, the WTRU may configure the devices to adjust the chip duration and/or the modulation and/or encoding types in a way that may shift the frequency in the ambient IoT UL band.

In one example, the WTRU may request all the devices to transmit with either full amplification, subject to its capability, no amplification, and/or a range of amplification.

In one example, the WTRU may receive the D2R signals, backscattered on the CW signals transmitted by the candidate CW nodes.

In one example, the WTRU may receive an indication of transmission characteristics (e.g., different transmission time, frequency, power, beam, reflecting devices, etc.) for one or more candidate CW nodes. The indication may correspond to a mapping between the candidate CW node and different transmission properties. For example (e.g., as illustrated in FIG. 5), the WTRU may receive the time and/or frequency indications and the associated transmission characteristics associated with one or more candidate CW nodes.

Upon receiving the D2R signals, a WTRU may perform the configured measurements. In one example, the WTRU may perform one or more of the RSRP, SINR, RSRQ, RSSI, and/or interference measurements in the indicated time and/or frequency occasions.

In one example, as the receiving WTRU may be one of the candidate CW nodes, the WTRU may receive and perform measurements while transmitting the CW signal. This may require the WTRU to be capable of full duplex transmission and reception.

In one example, the WTRU may perform and/or process at least one of the measurements in the configured measurement gap.

In one example, the WTRU may be configured to determine the measurements based on one or more of the following: per transmission characteristics (e.g., time occasion, frequency occasion, transmission power, transmission beam, etc.); per ambient IoT device; and/or, per candidate CW node.

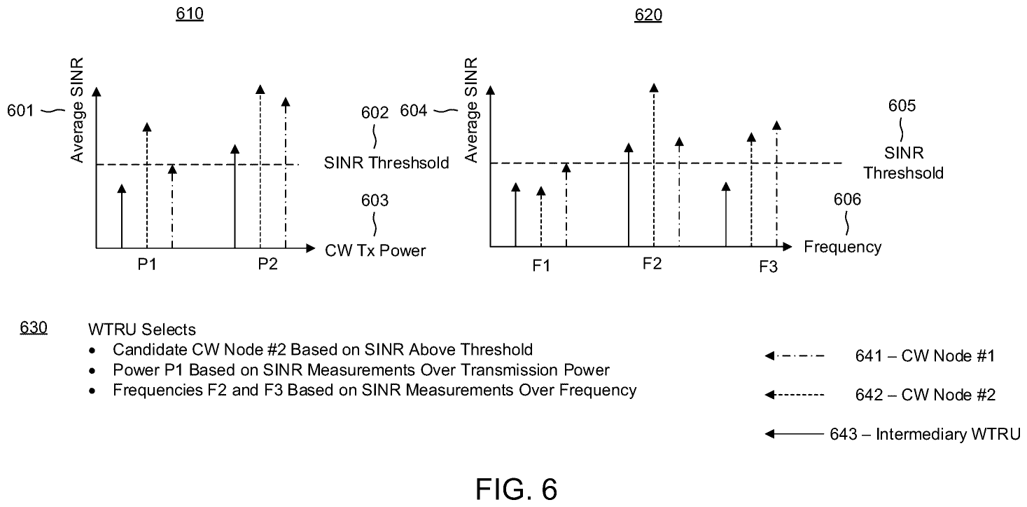

FIG. 6 illustrates an example of measurements and the selection of a candidate CW node based on measurements. As an initial note, each arrow may correspond to measurements of the entities of FIG. 5. CW Node #1 641, CW Node #2 642, and Intermediary WTRU 643. As shown there are two graphs, 610 illustrating measurements of average SINR 601 relative to CW Tx power 603, and 620 illustrating measurements of average SINR 604 relative to frequency 606. Each graph may have a SINR threshold (602, 605). A WTRU may make a selection depending on different criteria, as shown at 630. In one instance, the WTRU may select candidate CW node #2 based on SINR above a threshold. In one instance, the WTRU may select power P1 based on SINR measurements over a transmission power. In one instance, the WTRU may select frequencies F2 and F3 based on SINR measurements over frequency.

In an example, such as shown in FIG. 6, the WTRU may perform measurements corresponding to three candidate CW nodes. The entities of each measurement may correspond to the entities of FIG. 5. The WTRU may perform a SINR measurement for the candidate CW nodes per transmission characteristics, including transmission power (e.g., with respect to power P1 and P2), and transmission frequency (e.g., with respect to frequencies F1, F2 and F3). The measurements corresponding to each time and/or frequency occasion may comprise of SINR measurements averaged over one or more devices transmitting the D2R signals (e.g., with the respective candidate).

In one example, the WTRU may be able to determine the measurement based specifically on criteria, such as those described herein with respect to FIGS. 5 and 6, if the resources associated with the criteria are orthogonal.

The WTRU may be able to determine at least one measurement per transmission characteristic if the transmission characteristic is orthogonal in the measured time and/or frequency occasion. For instance, a WTRU may receive two beams (e.g., from one or more candidate CW nodes) and may be able to determine measurement per beam if the beams are spatially orthogonal. In one example, the WTRU may measure each time and/or frequency occasion corresponding to one unique measurement characteristic. In another example, the WTRU may be able to determine the measurement per characteristic if the D2R transmission corresponds to one unique power and/or beam per time and/or frequency occasions (e.g., in FIG. 6).

The WTRU may be able to determine at least one of the measurements per device, if one or more devices transmit orthogonal sequences in the measured time and/or frequency occasion. In one example, if the WTRU determines that the sequences transmitted by the devices are not orthogonal, the WTRU may not be able to perform the measurement per device. The WTRU may determine to average the measurement over the transmitting devices (e.g., as in FIG. 6). In one example, the WTRU may determine orthogonal device transmissions if one device is configured to transmit in every time and/or frequency occasion.

In one example, the WTRU may be configured to determine at least one measurement per device group. For instance, the WTRU may configure only a group of device(s) to transmit the D2R signal (e.g., backscattered) in one time and/or frequency occasion. In one example, the group of devices may be the devices in one location (e.g., area or within a certain distance from the reader, CW node, etc.) or with one device property (e.g., energy availability, energy storage capacity, etc.). In one example, the WTRU may indicate only the devices of a group to transmit the D2R signals and perform measurements. The WTRU may determine that the measurement associated with the group of device(s) may correspond to the measurement associated with the device group characteristic.

The WTRU may be able to determine at least one measurement per candidate CW node the transmission if one or more CW nodes transmit orthogonally in the measured time and/or frequency occasion. For instance, the CW transmission in one measurement may be orthogonal if the transmitted CW signal is orthogonal. Otherwise, the WTRU may be able to perform a measurement(s) per candidate CW node in one time and/or frequency occasion if the one candidate CW node transmits in the measured time and/or frequency occasion.

In the example illustrated in FIG. 5, the WTRU may perform the measurement and averaging over all the time and/or frequency resources associated with one CW node (e.g., one color in the time-frequency grid) to determine the measurement per CW node.

In one example, the WTRU may be configured to perform a measurement averaging based on measurements in one or more occasions (e.g., time occasions, frequency occasions). In one example, the WTRU may perform the measurement averaging based on the measurements to determine the measurement of one transmission characteristic and/or one device and/or one candidate CW node in one or more time and/or frequency occasions if they correspond to transmissions with the same transmission characteristic, same device, and/or same candidate CW node.

In one example, the WTRU may receive one time and/or measurement occasion corresponding to one transmission characteristic of one candidate CW node. The WTRU may perform one or more measurements for the transmission characteristic associated with the one candidate CW node by averaging the results over the measured time and/or frequency occasion associated with the particular transmission characteristic of the candidate CW node.

In one example, the WTRU may be configured with a minimum number of measurement(s) or sample(s) that the WTRU may require for averaging to determine a measurement. The WTRU may only determine a measurement if it is derived from averaging the configured number of measurement(s) or sample(s).

In another example, the WTRU may be configured with an L3 averaging weight where the WTRU may perform measurements in more than one measurement occasion. The WTRU may be configured to perform filtering over the measurements by applying an indicated weight(s) based on the measurement or measurement occasion. In one example, the WTRU may perform the L3 filtering on the measurements per transmission characteristics and/or per device and/or per candidate CW node. In one example, the WTRU may be configured to consider measurements without L3 filtering (e.g., measurement is associated with each instance).

In one example, the WTRU may receive device-related information from the transmitting devices (e.g., in the backscattered D2R signal). For example, the WTRU may receive an indication of device location in the message.

In one example, the WTRU may be configured to measure the interference signal. The WTRU may determine that the CW signal transmitted by one or more of the candidate CW nodes received without D2R backscattering may cause interference.

In one example, the WTRU may be configured to indicate the devices that should not transmit or that should transmit with zero power for D2R transmissions. In such cases, the WTRU may measure only the interference CW signal without any D2R transmissions. In another example, the WTRU may measure the received signal corresponding to the first path (e.g., direct path) from the candidate CW node. In one example, the WTRU may be able to determine the measurements corresponding to the first path if at least if the measurement bandwidth is above a (pre)configured threshold, The WTRU may determine the interference power based on the received signal power without D2R backscattering as the first path may contain only CW signal without the reflection from the device through the indirect path.

In another example, the WTRU may be configured to acquire the interference CW signal. The WTRU may use the acquired signal for interference cancellation.

In one example, the WTRU may be configured to report the interference power or the (e.g., characteristics of) the interference signal.

In some cases, a WTRU may be configured to determine the transmission CW node by the network. In one example, the WTRU may receive an indication of constraint(s) on one or more transmission characteristics associated with a set of candidate CW nodes. The WTRU may receive at least one of the following: Candidate CW node ID; at least one available transmission beam (e.g., in terms of beam ID(s)); at least one available transmission power (e.g., in terms of watts, dBm) (e.g., one transmission power may be associated with one or more candidate transmission beams); at least one available time indication (e.g., similarly to at least one of the CW time window parameters or WTRU CW transmission time indication parameters); and/or, at least one available frequency indication (e.g., similarly to at least one of the WTRU CW transmission frequency indication parameters).

In one example, the available power or the available beam may indicate the set of available transmission power(s) and/or transmission beams that may be transmitted by the candidate CW node.

In another example, the WTRU may receive configurations or assistance information regarding one or more constraints associated with the CW transmission characteristics. The WTRU may determine to select one or more candidate CW nodes and/or associated transmission characteristics based on one or more of the following: number of transmission CW nodes and/or expected measurement threshold at an indicated location.

For the number of transmission CW nodes, in one example, the WTRU may receive an indication from the network of (e.g., maximum, minimum, etc.) number of transmission CW nodes that the WTRU may determine. In one example, the WTRU may determine the number of transmission CW nodes to select based on one or more of the following: the (e.g., maximum, minimum) number of candidate CW nodes (e.g., configured for subsequent ambient IoT procedure); the (e.g., configured) expected number of device(s) (e.g., maximum, minimum) that the transmission CW nodes may serve (e.g., associated with the subsequent ambient IoT procedure); the (e.g., maximum, minimum) duration associated with the subsequent ambient IoT procedure; the (e.g., maximum, minimum) expected number of occasions (e.g., time and/or frequency) associated with the subsequent ambient IoT procedure; the configured number of readers in proximity (e.g., of the WTRU, CW node, etc.); and/or, indication from the network.

In one example, the WTRU may determine the transmission CW nodes based on the total number of transmission CW nodes.

In another example, the WTRU may determine one or more of the transmission characteristics of one or more of the transmission CW node(s) based on the determined configured number of transmission CW nodes. For instance, the WTRU may determine one number of transmission beams or one transmission power if the number of transmission CW nodes is above a (pre)configured threshold, and another number of transmission beams or another transmission power is otherwise.

For the expected measurement threshold at an indicated location, a WTRU may be configured to determine the transmission CW node and/or its associated transmission characteristic based on an expected measurement (e.g., maximum threshold, minimum threshold) in an indicated location.

In one example, the WTRU may be configured with the expected measurement (e.g., RSSI, SINR, RSRQ, RSRP, Interference, etc.) at one or more indicated locations. For instance, the WTRU may be configured with locations where at least one of the measurements(s) may require to be at, above, or below a (pre)configured minimum measurement threshold.

For example, the WTRU may be configured with an area where one of the expected measurements may be at, above, or below a (pre)configured minimum and/or maximum threshold.

In one example, the WTRU may determine at least one available or candidate transmission power and/or transmission beam for at least one candidate CW node based on one or more of the following: available transmission power and/or the available transmission beam, indicating the set of available transmission power(s) and/or transmission beams that may be transmitted by the candidate CW node.

For the available transmission power, for example, a WTRU may determine at least one available transmission power for one or more candidate CW nodes to determine the transmission CW node based on one or more of the following: distance between the candidate CW node and the indicated location; and/or distance between the candidate CW node and one or more devices locations (e.g., location of reference devices, expected location of the devices (e.g., for subsequent procedures, average location difference, etc.) For the available transmission beam, for example, the WTRU may determine at least one available transmission beam(s) for one or more candidate CW nodes based the transmission beam(s) that are spatially aligned with the indicated location.

For instance, if the WTRU is indicated to determine the CW node with one expected measurement (e.g., RSRP) at a location below a threshold, the WTRU may determine to remove the beam spatially aligned towards the indicated location of the candidate CW node in the set of associated candidate transmission beams. Likewise, the WTRU may determine the maximum available transmission power for a candidate CW node based on the distance between the CW node and the indicated location.

In one example, the WTRU may determine a new set of candidate CW nodes (e.g., a subset of the candidate CW nodes) based on one or more of the configured or determined constraints, as described herein.

In one example, the location may be in terms of a geographical location, area, distance from the WTRU or a reader, and/or the like. In one example, the location may correspond to the locations of one of the reader(s), device(s), CW nodes, etc. In such a case, the WTRU may receive an indication of the location in terms of at least one of the identifiers indicating the entity (e.g., reader ID(s), CW node ID, device ID (e.g., reference device ID), etc.)

In one example, the WTRU may be configured to determine one or more transmission CW node(s) from a set of one or more candidate CW nodes based on one or more of the following: one or more of the measurements, location of the CW node, resource availability of the CW node, and/or transmission/reception characteristic of other readers.

For the one or more of the measurements, in one example, the WTRU may determine the transmission CW node(s) based on at least one or a combination of performed measurements (e.g., RSRP, RSSI, SINR, RSRQ, interference etc.).

In one example, the WTRU may be configured to determine the transmission CW node based on measurements per candidate CW node. The WTRU may determine to select a candidate CW node based on one or more of the following conditions: one or more measurement(s) associated with the candidate CW nodes is at, above, or below a (pre)configured threshold; the uncertainty associated with one or more measurement(s) associated with the candidate CW nodes is at, above, or below a (pre)configured threshold; the number of samples or measurements used to determine the measurement(s) associated with the candidate CW nodes is at, above, or below a (pre)configured threshold; and/or, the difference between measurement(s) between two measurement instances associated with the candidate CW node is at, above, or below a (pre)configured threshold.

In another example, the WTRU may determine the transmission CW node based on the measurement per device.

The D2R transmission (e.g., backscattering) from one or more device(s) may indicate the coverage area or location where the CW signals from one or more CW nodes may be reflected from. For example, the WTRU may indicate a group of devices in one location (e.g., area) to transmit a CW signal from one CW node in one time and/or frequency occasion. The WTRU may determine the measurement of the D2R signals from the devices of the indicated location.

In one example, the WTRU may determine the device location to determine the transmission CW node based on one or more of the following: the area or location where the WTRU may be configured to perform the subsequent Ambient IoT procedures (e.g., random access, query, etc.); the distance from the WTRU where the devices may receive and decode the indications and/or messages from the WTRU (e.g., expected measurements above a (pre)configured threshold); the location where at least one of the expected measurements is at, above, or below a (pre)configured threshold; and/or, configuration from the network.

In another example, the WTRU may receive device location(s) in the D2R transmitted signal. If the measured interference is low or below a (pre) configured threshold, the WTRU may be able to decode the device location in the D2R signal.

In one example, the WTRU may indicate a group of devices with certain device characteristics (e.g., energy availability, energy storage capacity, device type, etc.) to transmit.

In another example, the WTRU may determine to transmit one or more device characteristics in group indication based on one or more of the following: the expected sustainable operation time associated with the subsequent ambient IoT procedures; the expected device types the subsequent ambient IoT procedures may involve; configuration from the network; and/or, the expected device energy requirement (e.g., based on expected number of transmissions) in subsequent ambient IoT procedures (e.g., random access, command, etc.). The expected device energy requirement may be determined based on one or more of the following: expected number of time and/or frequency occasions; and/or, expected number of devices the WTRU may transmit R2D messages/indications to, and/or receive D2R messages/indications from.

In one example, the WTRU may determine to select a candidate CW node based one or more of the following conditions: the uncertainty associated with one or more measurement(s) (e.g., corresponding to a device or a group of devices) associated with the candidate CW node is at, above, or below a (pre)configured threshold; the number of samples or measurement used to determine the measurement(s) (e.g., corresponding to a device or a group of devices) associated with the candidate CW node is at, above, or below a (pre)configured threshold; the difference of measurement(s) between measurement occasion(s) associated with a device or a group of device(s) is at, above, or below a (pre)configured threshold; and/or, the candidate CW node with one or more measurement(s) corresponding to a device or a group of devices that is at, above, or below a (pre)configured threshold. The group may be defined as one or more of the following: the devices located in one or more (e.g., configured or determined) locations; and/or, the devices with one or more device (e.g., configured or determined) characteristics (e.g., the devices with certain energy availability above a (pre)configured threshold; the devices with certain mobility characteristics (e.g., velocity) at, above, or below a (pre)configured threshold; the devices with sustainable operation time above a (pre)configured threshold; etc.).

In another example, the WTRU may be configured to determine the transmission CW node based on the measurements per transmission characteristics.

In one or more of the examples described herein, one consideration for the transmission characteristics has been transmission time, transmission frequency, power, and beam. However, the same examples and conditions may be valid for more transmission characteristics by replacing one of the defined transmission characteristics with more transmission characteristics.

The channel between the candidate CW node, device and the WTRU may be frequency selective. This may be caused due to a delay spread of the channel. In one example, the WTRU may determine that the measurement associated with one or more candidate CW nodes may be frequency-selective.

The WTRU may determine the transmission CW, from a set of candidate CW nodes based on one or more of the following conditions: the candidate CW node with one or more measurement(s) associated with one or more (e.g., indicated, determined) frequency occasion(s) or frequency range(s) is at, above, or below a (pre)configured threshold; the candidate CW node with the average of at least one or more measurement(s) over one or more (e.g., indicated, determined) frequency occasion(s) or frequency range(s) is at, above, or below a (pre)configured threshold; the candidate CW node with the uncertainty associated with one or more measurement(s) (e.g., corresponding with one or more (e.g., indicated, determined) frequency occasion(s) or frequency range(s) is at, above, or below a (pre)configured threshold; the candidate CW node with the number of samples or measurements used to determine one or more measurement(s) (e.g., corresponding with one or more (e.g., indicated, determined) frequency occasion(s) or frequency range(s) is at, above, or below a (pre)configured threshold; and/or, the candidate CW node with the difference of measurement(s) between measurement occasion(s) associated with one or more (e.g., indicated, determined) frequency occasion(s) or frequency range(s) is at, above, or below a (pre)configured threshold.

In some instances, the measurement(s) may be associated with one or more frequency occasion(s) indicated or determined as available for the candidate CW node.

In one example, such as shown in FIG. 6, a WTRU may perform an average SINR measurement (e.g., average over one or more devices) per frequency occasion from three candidate CW nodes. The WTRU may determine/select CW Node #2 since its SINR corresponding to frequency occasions F2 and F3 are above the SINR threshold.

Similarly, the measurement(s) for one or more CW nodes may vary due to different transmission power. This may be due to varying distances between the candidate CW node, devices, and the WTRU.

The WTRU may determine the transmission CW, from a set of candidate CW nodes based on one or more of the following conditions: the candidate CW node with one or more measurement(s) associated one or more transmission power is at, above, or below a (pre)configured threshold; the candidate CW node with the measurement uncertainty associated with one or more measurement(s) associated one or more transmission power is at, above, or below a (pre)configured threshold; the candidate CW node with the number of samples or measurement used to determine one or more measurement(s) associated with one or more transmission power is at, above, or below a (pre)configured threshold; and/or, the candidate CW node with the difference of one or more measurement(s) between measurement occasion(s) associated with one or more transmission power is at, above, or below a (pre)configured threshold.

In one example, the measurement(s) may be associated with one or more transmission power(s) indicated or determined as available for the candidate CW node.

Likewise, the measurement(s) for one or more CW nodes may vary due to different transmission beams. Transmission beams of CW signals from the candidate CW nodes may define the coverage of devices. In another example, the transmission beam directed towards the WTRU or one of the readers may cause interference (e.g., co-channel interference).

The WTRU may determine the transmission CW, from a set of candidate CW nodes based one or more of the following conditions: the candidate CW node with one or more measurement(s) associated one or more transmission beams is at, above, or below a (pre)configured threshold; the candidate CW node with the measurement uncertainty associated with one or more measurement(s) associated one or more transmission beams is at, above, or below a (pre)configured threshold; the candidate CW node with the number of samples or measurement used to determine one or more measurement(s) associated with one or more transmission beams is at, above, or below a (pre)configured threshold; and/or, the candidate CW node with the difference of one or more measurement(s) between measurement occasion(s) associated with one or more transmission beams is at, above, or below a (pre)configured threshold.

In one example, the measurement(s) may be associated with one or more transmission beam(s) indicated or determined as available for the candidate CW node.

For the location of the CW node, in one example, the WTRU may be configured to determine the transmission CW node based on their location, based on one or more of the following conditions: the distance between the WTRU and the candidate CW node is at, above, or below a (pre)configured threshold; and/or, the distance between the candidate CW node and one or more of other entities (e.g., readers, devices, etc.) is at, above, or below a (pre)configured threshold.

For the resource availability of CW node, in one example, the WTRU may determine to select one or more transmission CW nodes based on one or more of the candidate CW nodes based on the resource availability of the CW node. The WTRU may determine one or more transmission CW nodes based on one or more of the following: expected time indication (e.g., duration, time window, etc.) of one or more (e.g., subsequent) ambient IoT procedures for which the CW node selection is considered; expected frequency indication (e.g., frequency band, frequency index etc.) of one or more (e.g., subsequent) ambient IoT procedures for which the CW node selection is considered; at least one available time indication of the candidate CW node; and/or, at least one available frequency indication of the candidate CW node.

In one example, the WTRU may be configured to only consider the CW node if the available time (e.g., start time) is during the expected time (e.g., start time) of the subsequent procedures.

For transmission/reception characteristics of other readers, in one example, the WTRU may determine the transmission CW node such that the CW node may not interfere with the readers. The WTRU may determine to select the CW nodes based on one or more of the following: expected time indication (e.g., duration, time window, etc.) of one or more (e.g., subsequent) ambient IoT procedure for which the CW node selection is considered; expected frequency indication (e.g., frequency band, frequency index etc.) of one or more (e.g., subsequent) ambient IoT procedures for which the CW node selection is considered; at least one available time indication of the candidate CW node; at least one available frequency indication of the candidate CW node; at least one available time indication of the procedure of at least one of the other readers; at least one available frequency indication of the procedure of at least one of the other readers; and/or, proximity between the candidate CW node and at least one of the other readers.

In one example, the WTRU may select a CW node such that if the time of the subsequent procedure overlaps with the procedure of one of the readers, the overlap between the frequency indication of the procedure of the reader and the available frequency of the CW node is below a (pre)configured threshold. For example, the WTRU may select a CW node that transmits in the ambient IoT DL band if the reader procedure involves D2R receptions (e.g., in the ambient IoT uplink band). For e.g., the WTRU may select a CW node that transmits in the UL band if the reader procedure involves R2D transmission in the ambient IoT DL band to avoid interference.

In one example, the WTRU may be configured to determine at least one of the transmission characteristics of one or more selected transmission CW nodes, where a transmission characteristic may be one or more of the following: transmission time, transmission frequency, transmission power, and/or transmission beam.

For transmission time, in one example, the WTRU may be configured to determine a transmission time of a selected CW node based on at least one or more of the following: expected time indication (e.g., duration, time window, etc.) of one or more (e.g., subsequent) ambient IoT procedures for which the CW node selection is considered; at least one available time indication of the candidate CW node; at least one time indication of the procedure of the reader (e.g., in the proximity of the CW node); and/or, configuration from the network.

In one example, the transmission time of a transmission CW node may be for the whole duration of one or more (e.g., subsequent) WTRU procedures for ambient IoT. In another example, the WTRU may determine the transmission time of the transmission CW node for a partial duration of the procedure.

In one example, the partial duration may be due to the availability of the transmission CW node. In another example, the partial duration may be to avoid interference with the readers or devices in proximity (e.g., a threshold distance away, where the distance is small enough that interference is a problem). In one example, the WTRU may determine the time duration based on the distance between the transmission CW node and the reader node.

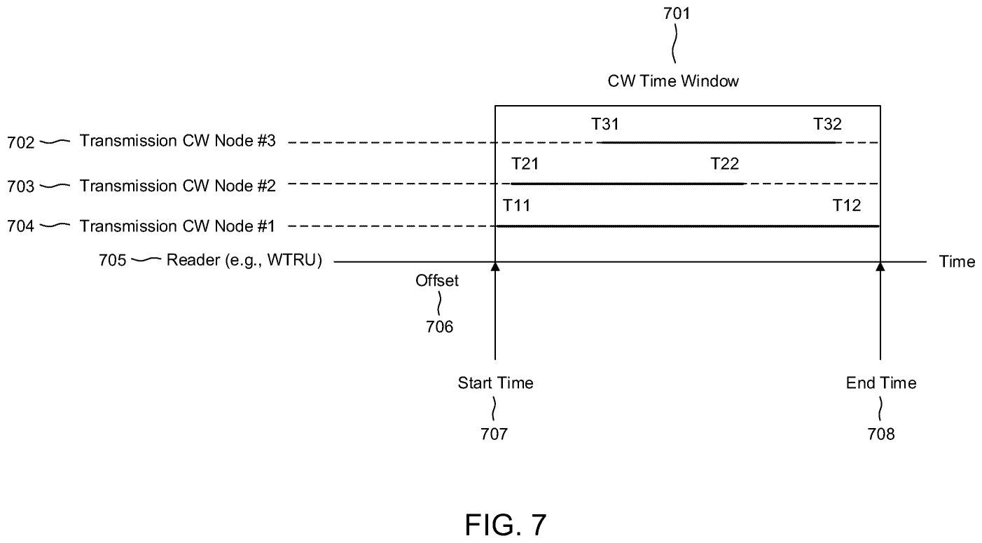

FIG. 7 illustrates an example of the time availability of one or more transmission CW nodes. As shown, there is a CW time window 701 with an initial start time 707 and an end time 708. There may be an offset 706 prior to the start time 707. The availability of three transmission CW nodes (702, 703, 704) is shown relative to the CW time window 701, and a reader (e.g., WTRU) 705.

In an example, such as illustrated in FIG. 7, the transmission times of the transmission CW nodes are indicated with a thick line, with indicated times TJ1 and TJ2, where J represents the index associated with the Transmission CW Node #J, and TJ1 and TJ2 indicates the start and end times, respectively, of the transmission time for each transmission CW nodes. The transmission time for the transmission node #1 may be the whole duration with the start and the end times being the same as the start and the end times of the CW time window. However, the transmission times for transmission nodes #2 and transmission nodes #3 may be partial duration compared to the CW time window duration.

In one example, the transmission time may also indicate the “On” period or “Off” period associated with one or more transmission CW nodes.

For transmission frequency, in one example, the WTRU may determine the frequency of one or more transmission CW nodes based on one or more of the following: expected frequency indication (e.g., frequency band, frequency index etc.) of one or more (e.g., subsequent) ambient IoT procedures for which the CW node selection is considered; one or more of the measurements of the transmission CW node associated with one or more frequency; one or more of the measurements of the other transmission CW node associated with one or more frequency; at least one available frequency occasion of the candidate CW node; at least one frequency indication of the procedure of the reader (e.g., in the proximity of the CW node); and/or, configuration from the network.

In one example, the WTRU may determine one or more frequency bands (e.g., ambient IoT downlink band, ambient IoT uplink band) based on indication from the network. In another example, the WTRU may determine based on one or more frequency availability of one or more transmission CW nodes.

For example, the WTRU may determine that the transmission CW nodes, transmitting in overlapping time instances, may be associated with one frequency band. In another example, the WTRU may determine the set of frequencies based on the available frequency resource of one or more transmission CW nodes.

In another example, the WTRU may determine the transmission frequency of the transmission CW nodes in order to avoid interference with one or more readers and/or devices in proximity. For instance, the WTRU may determine to select the frequency band and/or set of frequencies based on the transmission or reception frequency indicated by the procedure involving the reader in proximity to the CW node. For instance, if the reader procedure is a D2R transmission in ambient IoT uplink band, the WTRU may determine to indicate the frequencies in the DL band or resource(s) to not overlap with the reader or devices.

In another example, the WTRU may indicate more than one set of frequencies for each transmission CW node. In one example, if the indicated frequencies and/or time associated with more than one transmission CW nodes may overlap, then the WTRU may, determine a frequency hopping pattern for the devices. The WTRU may indicate a set of frequency occasions for each transmission CW node. In one example, the WTRU may associate each frequency occasion with a time occasion for a frequency hopping pattern. In one example, the set of time and/or frequency occasions for more than one CW node may be orthogonal to each other.

For transmission power, in one example, the WTRU may determine the transmission power of one or more transmission CW nodes based on one or more of the following: one or more of the measurements of the transmission CW node associated with one or more transmission power; at least one of the determined or indicated available transmission power for at least one transmission CW node; expected number of devices in one or more (e.g., subsequent) ambient IoT procedures for which the CW node selection is considered; number of readers (e.g., in proximity of the transmission CW node); location of the readers (e.g., in proximity of the transmission CW node); location of the one or more devices (e.g., associated with the WTRU or the reader, in proximity of the transmission CW node); distance between at least one the transmission CW node and at least one reader; and/or, a determined transmission time and/or frequency of the transmission CW node.

In one example, the WTRU may be configured to determine at least one transmission power for at least one CW node per determined transmission beam.

In one example, the WTRU may determine the transmission power such that one or more of the measurements of the transmission CW node associated with selected transmission power may be at, above, or below a (pre)configured threshold. For instance, the WTRU may determine to select a transmission power associated with one CW node with SINR measurement above a (pre)configured threshold. In another example, if the WTRU determines that more than one measurement associated with more than one transmission power may be associated with at least one of the measurements at, above, or below a threshold, the WTRU may determine to select one transmission power (e.g., the lowest transmission power) from the available set. In another example, the WTRU may report more than one set of transmission power to the network, for one transmission CW node.

In another example, the WTRU may be configured to report at least one of the transmission powers associated with the transmission CW node during the CW node selection procedure. In another example, the WTRU may determine to report another transmission power that may be slightly at, above, or below one of the transmission powers. In one example, the WTRU may report a delta value for power increase or decrease for the CW transmission. For instance, if the WTRU measures SINR slightly below threshold for transmitted power P1, the WTRU may be configured to report power P1 for the transmission CW node, with a delta power increase value of P, indicating the network to select the transmission CW node transmission power as the sum of P1 and P.

In another example, the WTRU may determine the transmission power in order to minimize interference to other readers and/or devices. In one example, the WTRU may determine to transmit based on the distance between the transmission CW node and the reader(s) and/or devices in its proximity.

In one example, the WTRU may be configured to determine the transmission power per determined transmission time and/or transmission frequency. For example, the WTRU may determine one transmission power on one transmission time and another transmission power in another transmission time based on overlap between the transmission times of the (e.g., subsequent) WTRU procedures and procedures of other readers. For e.g., if another reader is performing an ambient IoT procedure in the same time and/or frequency resources as the reader, the WTRU may select the transmission power as the lowest from the set of available transmission power, for e.g., to reduce interference. The WTRU may select a higher transmission power otherwise.

As illustrated in FIG. 6, the WTRU may determine the transmission CW and the associated CW based on measurements per transmission power. The WTRU may select candidate CW node #2 as the transmission node based on measurement per power P1 and P2 being above the SINR threshold. In one example, the WTRU may select to transmit with a lower transmission power (e.g., P1) in order to reduce interference to the WTRU.

For the transmission beam, in one example, the WTRU may determine the transmission beam of one or more transmission CW nodes based on one or more of the following: one or more of the measurements of the transmission CW node associated with one or more transmission beams; at least one of the determined or indicated available transmission beams for at least one transmission CW node; expected number of devices in one or more (e.g., subsequent) ambient IoT procedures for which the CW node selection is considered; number of readers (e.g., in proximity of the transmission CW node); location of the readers (e.g., other readers in proximity of the transmission CW node); location of the one or more devices (e.g., associated with the WTRU or the reader, in proximity of the transmission CW node); distance between at least one the transmission CW node and at least one reader; and/or, determined transmission time and/or frequency of the one or more transmission CW node.

In one example, the WTRU may determine to associate at least one transmission power, transmission time, and/or transmission frequency to each transmission beam (e.g., associated with the transmission CW node).

In one example, the WTRU may determine the transmission beam of at least one transmission CW node in order to ensure coverage of a given location and/or an area. In one example, the WTRU may determine the beam such that the measurement associated devices in the coverage area of the beam is at, above, or below a (pre)configured threshold. In one example, the location and/or an area may be indicated in terms of location of an entity (e.g., WTRU, at least one of the CW nodes, at least one of the devices etc.).

For example, the WTRU may be configured determine the transmission beam to minimize the measured interference at the WTRU from the transmission CW signal. In such case, the WTRU may determine to either not determine the beam in the direction of the WTRU or determine the beam with low transmission power such that the measured interference with the power may be below a (pre)configured threshold.

For example, the WTRU may be configured to determine the transmission beam to minimize interference to other readers or devices not associated with the procedure of the WTRU. The WTRU may determine for one or more transmission CW nodes to not transmit in the directions of locations of other readers or devices if the WTRU determines that the readers or devices are in proximity of the transmission CW node.

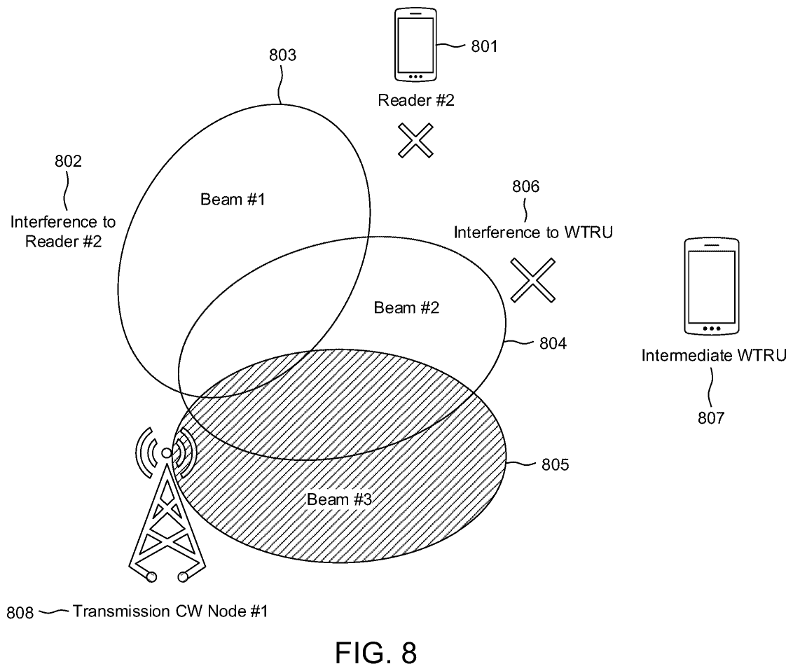

FIG. 8 illustrates an example of selecting a transmission beam to avoid interference with a WTRU and a reader in close proximity. As shown, there may be a reader (#2) 801 and an intermediate WTRU 807. Further, there is a transmission CW node (#1) 808, which may have three beams 803, 804, and 805. One or more of these beams may cause interference (e.g., at 806 showing interference to a WTRU, or at 802 showing interference to reader #2). At 806, the CW may be transmitted to the devices and backscattered; any signal (e.g., CW without backscatter) may cause interference to the WTRU. Note, in this example reader #2 may be another reader (e.g., WTRU, base station, etc.) in the vicinity of the operation, but not part of the CW selection procedure; reader #2 may be involved in one or more other procedures independent of the WTRU; reader #2 may be affected by the transmission power or beam from the transmission CW #1 node, hence the transmission CW #1 node may not choose beam #1.

In some cases, there may be an association between the transmission characteristic parameters for a transmission CW node.

In one example, the WTRU may be configured to determine at least one transmission characteristic associated with at least one transmission CW node jointly.

In one example, the WTRU may be configured to determine at least one of the transmission characteristics in order to ensure at least one of the measurements based on the transmission characteristic is at, above, or below a (pre)configured threshold. For example, the WTRU may be configured determine the transmission time and/or frequency to ensure that they are within the expected time and/or frequency associated with one or more (e.g., subsequent) procedures for ambient IoT devices. For example, the WTRU may be configured to determine the transmission power and/or transmission beam based on the location (e.g., area) where the WTRU may perform one or more (e.g., subsequent) procedure for ambient IoT devices.

In another example, the WTRU may be configured to determine at least one of the transmission characteristics of at least one transmission CW node in order to minimize interference to the WTRU. For example, if the WTRU is a transmission CW node, the WTRU may determine to perform CW transmission in the downlink band of ambient IoT in order to reduce interference to the D2R signals in the uplink band ambient IoT. For example, the WTRU may determine the transmission beam and/or power of the transmission CW node in such a way to reduce the interference to the WTRU by choosing one set of transmission power(s) if the transmission beam is in the direction of the WTRU and another set (e.g., if there is another reader in the vicinity performing AIoT communication at the same time/frequency, the WTRU may transmit at a lower power; alternatively, if there is no other reader, or the other reader is not using the same time/frequency, then a higher transmit power may be used)

In another example, the WTRU may be configured to determine at least one transmission characteristics of at least one transmission CW in order to minimize the interference to other readers or devices. For example, the WTRU may determine the transmission beam and the transmission power (e.g., associated with the transmission beam) to minimize the interference to the reader(s) and/or devices not associated with one or more of the (e.g., subsequent) WTRU procedures by either not choosing the beam in the direction of the reader(s) and/or device(s). For example, if the WTRU has to choose the transmission beam, the WTRU may determine the beam with appropriate transmission power which minimize the interference to the readers and/or devices. For example, the WTRU may determine the transmission time and/or transmission frequency of the transmission power and/or transmission beam causing interference to the reader and/or devices in the time and/or frequency occasions where the reader is not performing any ambient IoT procedures.

In one case, the WTRU may be configured with one or more candidate CW transmission configurations (e.g., indicated with configuration ID(s)) where each configuration may correspond to at least one configuration parameter associated with at least one of the transmission characteristics of at least one CW node. In one example, the WTRU may determine the configuration ID based on the corresponding configuration values determined based on one or more of the above-mentioned conditions. In one example, the WTRU may be configured to determine the configuration based on the configuration ID, and/or determine and/or add one or more transmission characteristic parameters to the configuration ID and/or report the selected configuration ID for at least one transmission CW node.

A WTRU may be configured to send one or more reports to the network. In one example, the WTRU may be configured to report one or more of the following: at least one of more statistics (e.g., variance) associated with the measurements; time stamp associated with the reported measurements (e.g., in terms of symbol index, slot index, frame index, subframe index, absolute time (e.g., UTC time, GNSS time, etc.)); at least one determined transmission CW node (e.g., CW node ID, CW node location, etc.); at least one determined transmission characteristics of the transmission CW node (e.g., determined transmission time, determined transmission frequency, determined transmission power, determined transmission beam, etc., configuration ID(s) associated with transmission characteristic configuration of the transmission CW node, etc.); at least one candidate CW nodes (e.g., CW node ID, CW node location, etc.); number of measurement or samples associated (e.g., averaged) with each measurement; Received interference signal (e.g., CW signal without D2R backscattering or backscattering with all “on” sequences) or associated characteristics; and/or, one or more measurements (e.g., RSRP, SINR, RSSI, RSRQ, Interference, etc.), where each measurement may be associated with at least one or more transmission characteristics (e.g., CW transmission power, CW transmission frequency, CW transmission time, CW transmission beam, etc.), device(s), candidate CW nodes, and/or a combination thereof.

In one example, the WTRU may be configured to or may report the transmission characteristics of the transmission CW node in terms of at least one of the WTRU CW configuration parameters configured or indicated by the network. For example, the WTRU may report the transmission time of the transmission CW nodes in terms of one or more of the following: WTRU CW transmission time indications such as transmission start and/or end time, transmission duration, etc.; transmission frequency of the transmission CW nodes in terms of at least one of the WTRU CW transmission frequency indications such as transmission bandwidth, number of CW tones, etc.; transmission power of the transmission CW nodes in terms of at least one of the WTRU CW transmission power indications such as minimum power and maximum power; transmission beam of the transmission CW node in terms of at least one of the WTRU CW transmission beam indications such as beam ID(s); where the transmission characteristic indications are configured by the network for WTRU CW transmission.

In one example, the WTRU may determine to report to the network based on one or more of the following conditions: the WTRU determines the expiration of the CW time window; the WTRU determines the configured number of transmission CW nodes; the number of measurement associated with CW node selection procedure is above a (pre)configured threshold; at least one measurement condition is satisfied (e.g., at least one measurement is at, above, or below a (pre)configured threshold); and/or, a difference between at least one measurement in two measurement occasions is below a (pre)configured threshold.

In one example, the WTRU may report to the network in an RRC message, a MAC control element, or as uplink control information (e.g., in PUCCH or PUSCH). The reporting periodicity, reporting occasions, thresholds, and/or types of measurements for conditional reporting may be configured or indicated by RRC, MAC control element, system information (e.g., SIB, MIB, etc.) or downlink control information.

A WTRU may be configured for subsequent behavior.

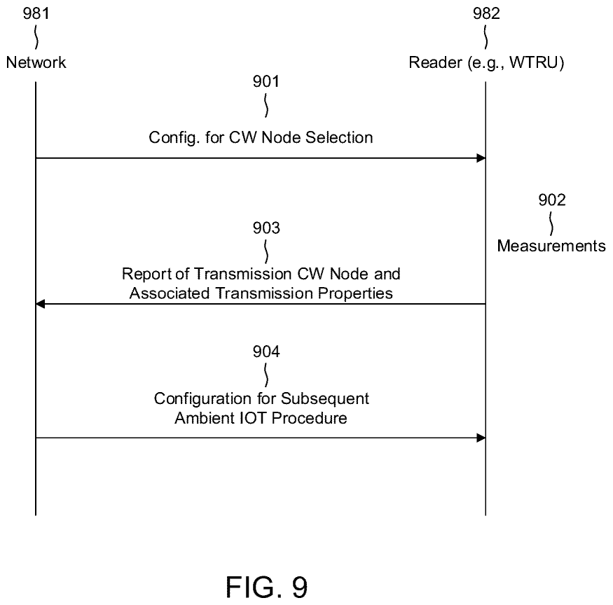

FIG. 9 illustrates an example of signaling for reporting transmission CW configurations. As shown, there may be signaling between at least a network 981 and a WTRU 982. At 901 the network may send configuration for CW node selection to the WTRU. At 902, the WTRU may perform measurements. At 903, the WTRU may report of transmission of CW Node and associated transmission properties to the network. At 904, the network may send configuration of subsequent AIoT procedure(s).

In one example, the WTRU may receive configuration for one or more (e.g., subsequent) ambient IoT procedures after the WTRU report for CW node selection procedure.

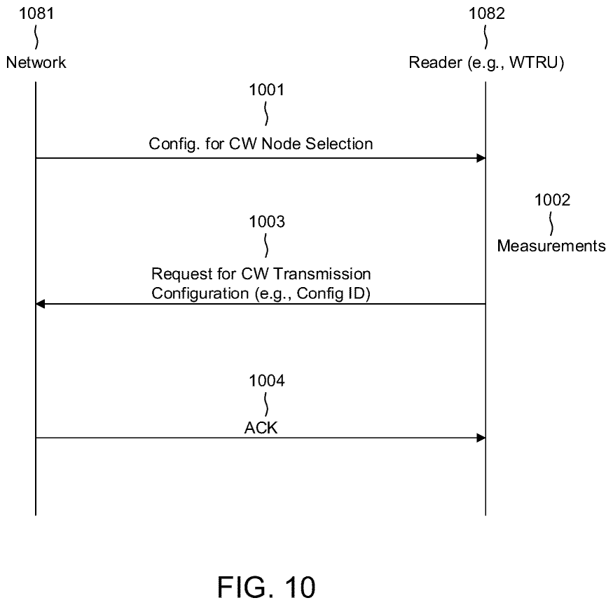

FIG. 10 illustrates an example of signaling for requesting transmission of CW configurations. As shown, there may be signaling between at least a network 1081 and a WTRU 1082. At 1001, the network may send configuration for CW node selection to the WTRU. At 1002, the WTRU may take measurements. At 1003, the WTRU may send a request for CW transmission configuration (e.g., config ID) to the network. At 1004, the network may send an ACK/NACK back to the WTRU. In the event of a NACK, the process may repeat. In the event of an ACK, the process may end.

In another approach, the report for CW node selection may be a request to the network for activation of one or more CW transmission configuration(s) (e.g., associated with one or more CW nodes). In one example, the request may be an on-demand request where the WTRU may determine to activate the configuration for one or more transmission CW nodes by indicating it to the network (e.g., with configuration ID).

In one example, the WTRU may receive an acknowledgement message (e.g., ACK) or a negative acknowledgement message (e.g., NACK) and/or a proposed CW transmission configuration. In one example, the WTRU may negotiate the configuration value with the network. In another example, the WTRU may determine to terminate the ambient IoT procedures.

In another approach, the WTRU may be configured to send the CW transmission configuration (e.g., configuration values, configuration ID(s), etc.) to at least one of the transmission CW nodes or the node (e.g., BS, gNB, another reader WTRU, etc.) controlling the transmission CW nodes. In one example, the WTRU may utilize one of the interfaces defined for communication between the WTRU and the CW nodes (e.g., sidelink PC5 interface or similar) or reader and the entity controlling the CW nodes (Uu interface or similar). In one example, the WTRU may receive an acknowledgement message (e.g., ACK) or a negative acknowledgement message (e.g., NACK) and/or a proposed CW transmission configuration from the CW node or the entity controlling the CW node.

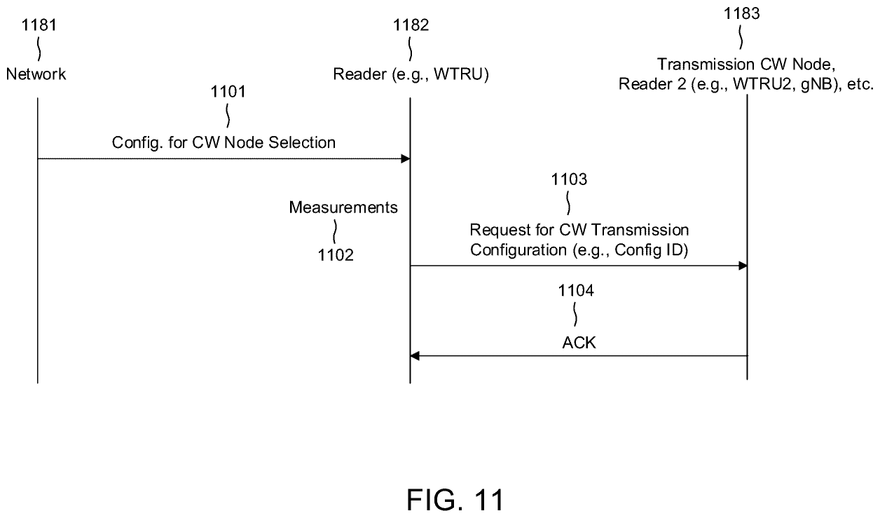

FIG. 11 illustrates an example of signaling for a WTRU to indicate CW configuration to another reader. As shown, there may be signaling between at least a network 1181, a WTRU 1182, and a third entity, such as a reader, a CW node, a second WTRU, a base station, etc. (1183). At 1101, the network may send configuration for CW node selection to the WTRU. At 1102, the WTRU may take measurements. At 1103, the WTRU may send a request for CW transmission configuration (e.g., config ID) to the third entity. At 1104, the third entity may send an ACK/NACK back to the WTRU. In the event of a NACK, the process may repeat. In the event of an ACK, the process may end.

In one example, the WTRU may receive configurations for CW transmission associated with one or more CW nodes where the CW node may or may not be at least one of the reported transmission CW nodes and the configuration parameters may or may not be at least one of the reported transmission characteristics associated with the CW nodes.

In one approach, after receiving the CW configuration or the indication (e.g., ACK, NACK), the WTRU may configure the devices for the subsequent WTRU procedures.

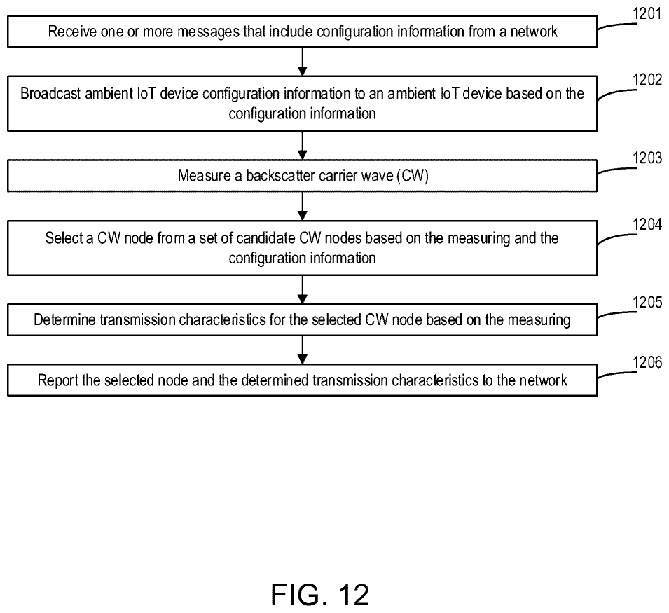

FIG. 12 illustrates an example method according to one or more embodiments disclosed herein. This method may be performed by a WTRU. At 1201, the WTRU may receive one or more messages that include configuration information from a network. At 1202, the WTRU may broadcast ambient IoT device configuration information to one or more ambient IoT devices based on the configuration information. At 1203, the WTRU may measure a backscatter carrier wave (CW) from the ambient IoT device. At 1204, the WTRU may select a CW node from a set of candidate CW nodes based on the measuring and the configuration information. At 1205, the WTRU may determine transmission characteristics for the selected CW node based on the measuring. At 1206, the WTRU may report the selected node and the determined transmission characteristics to the network. In some instances, the configuration information may include a candidate transmission CW node ID, a candidate transmission CW node location, a reference device ID, thresholds for transmission CW node selection, and/or a CW transmission configuration for the WTRU or candidate CW node. In some instance, the CW transmission configuration includes orthogonal transmission time resources, orthogonal transmission frequency sequences, transmission power, and/or transmission beams. In some instance, the ambient IoT device configuration includes a transmission time indication, an amplification, and/or a transmission sequence. In some instances, selecting the CW node may be further based on a distance between the candidate CW node of the set of CW nodes and the WTRU being above a threshold.

In one example, an intermediate reader WTRU may determine and report the identity of a CW node and its transmission characteristics (e.g., power, beam, frequencies, etc.) for AIoT transmission and reception based on measurements associated with more than one candidate CW nodes with different transmission characteristics.

A WTRU (e.g., intermediate reader WTRU) may receive configuration for transmission CW node selection including: one or more candidate transmission CW node ID and/or one or more candidate transmission CW node location; reference device ID(s); CW transmission configuration for the WTRU and candidate CW node(s) including orthogonal transmission time and/or frequency sequences, transmission power, transmission beams; and/or, thresholds for transmission CW node selection.

The WTRU may configure (e.g., via broadcast) the devices for D2R transmission, where the configuration may include: transmission time indication, amplification, transmission sequence, etc.

The WTRU may obtain measurements for one or more of the backscattered CW from the configured devices and/or CW from the candidate CW nodes. The measurements may include SINR, RSRP, RSRQ, interference, etc. The measurements may be determined per transmission characteristic (e.g., transmission power, beam, frequency, etc.). The measurements may be obtained per candidate CW node.

The WTRU may select one or more transmission CW node(s) from the one or more candidate CW node(s) based on at least one of the following: a measurement (e.g., SINR) associated with at least one transmission characteristic of a candidate CW node is above a threshold; and/or, the distance between the candidate CW node and the reader is above a threshold.

The WTRU may determine the transmission characteristics of the selected transmission CW node(s) based on at least one of the following: the minimum transmission power of the selected CW node such that a measurement (e.g., the SINR) is above a threshold; the transmission beam of the selected CW node such that a measurement (e.g., SINR) is above a threshold; and/or, the set of frequencies for which a measurement (e.g., SINR) is above a (pre)configured threshold.

The WTRU may report one or more of: the selected transmission CW node(s), the determined transmission characteristics of the selected CW node(s), and/or the measurements to the network.

As described herein, a higher layer may refer to one or more layers in a protocol stack, or a specific sublayer within the protocol stack. The protocol stack may comprise of one or more layers in a WTRU or a network node (e.g., eNB, gNB, other functional entity, etc.), where each layer may have one or more sublayers. Each layer/sublayer may be responsible for one or more functions. Each layer/sublayer may communicate with one or more of the other layers/sublayers, directly or indirectly. In some cases, these layers may be numbered, such as Layer 1, Layer 2, and Layer 3. For example, Layer 3 may comprise of one or more of the following: Non-Access Stratum (NAS), Internet Protocol (IP), and/or Radio Resource Control (RRC). For example, Layer 2 may comprise of one or more of the following: Packet Data Convergence Control (PDCP), Radio Link Control (RLC), and/or Medium Access Control (MAC). For example, Layer 3 may comprise of physical (PHY) layer type operations. The greater the number of the layer, the higher it is relative to other layers (e.g., Layer 3 is higher than Layer 1). In some cases, the aforementioned examples may be called layers/sublayers themselves irrespective of layer number, and may be referred to as a higher layer as described herein. For example, from highest to lowest, a higher layer may refer to one or more of the following layers/sublayers: a NAS layer, a RRC layer, a PDCP layer, a RLC layer, a MAC layer, and/or a PHY layer. Any reference herein to a higher layer in conjunction with a process, device, or system will refer to a layer that is higher than the layer of the process, device, or system. In some cases, reference to a higher layer herein may refer to a function or operation performed by one or more layers described herein. In some cases, reference to a high layer herein may refer to information that is sent or received by one or more layers described herein. In some cases, reference to a higher layer herein may refer to a configuration that is sent and/or received by one or more layers described herein.

Although features and elements are described above in particular combinations (e.g., embodiments, methods, examples, etc.), one of ordinary skill in the art will appreciate that each feature or element can be used alone or in any combination with the other features and elements. For example, as disclosed herein there may be a method described in association with a figure for illustrative purposes, and one of ordinary skill in the art will appreciate that one or more features or elements from this method may be used alone or in combination with one or more features from another method described elsewhere. A symbol ‘/’ (e.g., forward slash) may be used herein to represent ‘and/or’, where for example, ‘A/B’ may imply ‘A and/or B’. As used herein, ‘a’ and ‘an’ and similar phrases are to be interpreted as ‘one or more’ and ‘at least one’. Similarly, any term which ends with the suffix ‘(s)’ is to be interpreted as ‘one or more’ and ‘at least one’. The term ‘may’ is to be interpreted as ‘may, for example’ or indicate that something “does happen” or “can happen”. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random-access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

As disclosed herein, ‘a’ and ‘an’ and similar phrases are to be interpreted as ‘one or more’ and ‘at least one’ (where at least one and one or more may be interchangeable). Similarly, any term which ends with the suffix ‘(s)’ is to be interpreted as ‘one or more’ and ‘at least one’. The term ‘may’ is to be interpreted as ‘may, for example’. A symbol ‘/’ (e.g., forward slash) as used herein, unless otherwise indicated, represents ‘and/or’, where for example, ‘A/B’ may imply ‘A and/or B’.

As described herein, “etc.” may refer to etcetera, which is intended to reference any other like element in a list, or reference some other element disclosed herein. For example, if a list has “a, b, c, etc.” and another list disclosed herein discloses “a, b, c, d, e” then it is intended that the “etc.” may refer to at least “d, e” or “etc.” may generally refer to other letters in the alphabet.

As described herein, “at least one of” may be interchangeable with “one or more of”.

As described herein, reference of a configuration may mean that at some point a WTRU may receive a message that includes configuration information. In one instance, the WTRU may provide feedback after having received it. In one instance, the WTRU may request the message. In one instance, the message may be unrequested.

What is claimed:

1. A method performed by a wireless transmit receive unit (WTRU), the method comprising:
receiving one or more messages that include configuration information from a network;
broadcasting ambient IoT device configuration information to an ambient IoT device based on the configuration information;
measuring a backscatter carrier wave (CW) from the ambient IoT device;
selecting a CW node from a set of candidate CW nodes based on the measuring and the configuration information;
determining transmission characteristics for the selected CW node based on the measuring; and
reporting the selected node and the determined transmission characteristics to the network.

2. The method of claim 1, wherein the configuration information includes a candidate transmission CW node ID, a candidate transmission CW node location, a reference device ID, thresholds for transmission CW node selection, a CW transmission configuration for the WTRU or candidate CW node.

3. The method of claim 1, wherein the CW transmission configuration includes orthogonal transmission time resources, orthogonal transmission frequency sequences, transmission power, or transmission beams.

4. The method of claim 1, wherein the ambient IoT device configuration includes a transmission time indication, an amplification, or a transmission sequence.

5. The method of claim 1, wherein selecting the CW node is further based on a distance between the candidate CW node of the set of CW nodes and the WTRU being above a threshold.

6. A wireless transmit receive unit (WTRU) comprising:
means for receiving one or more messages that include configuration information from a network;
broadcasting ambient IoT device configuration information to an ambient IoT device based on the configuration information;
means for measuring a backscatter carrier wave (CW) from the ambient IoT device;
means for selecting a CW node from a set of candidate CW nodes based on the measuring and the configuration information;
means for determining transmission characteristics for the selected CW node based on the measuring; and
means for reporting the selected node and the determined transmission characteristics to the network.

7. The WTRU of claim 6, wherein the configuration information includes a candidate transmission CW node ID, a candidate transmission CW node location, a reference device ID, thresholds for transmission CW node selection, a CW transmission configuration for the WTRU or candidate CW node.

8. The WTRU of claim 6, wherein the CW transmission configuration includes orthogonal transmission time resources, orthogonal transmission frequency sequences, transmission power, or transmission beams.

9. The WTRU of claim 6, wherein the ambient IoT device configuration includes a transmission time indication, an amplification, or a transmission sequence.

10. The WTRU of claim 6, wherein selecting the CW node is further based on a distance between the candidate CW node of the set of CW nodes and the WTRU being above a threshold.
